(19) United States
(12) Patent Application Publication
(10) Pub. No.: US 2009/0210588 A1
(43) Pub. Date: Aug. 20, 2009

(54) Output Circuit, Control Program Product, and Control Method

(76) Inventors: Makoto Adachi, Nara (JP); Atsushi Nakao, Nara (JP); Hiromichi Ito, Tokyo (JP); Noboru Sugihara, Tokyo (JP)

Correspondence Address: BIRCH STEWART KOLASCH & BIRCH, PO BOX 747, FALLS CHURCH, VA, 22040-0747, US

(21) Appl. No.: 11/988,287

(22) PCT Filed: Jul. 3, 2006
(86) PCT No.: PCT/JP2006/313230

§ 371 Date: Jan. 4, 2008

(30) Foreign Application Priority Data
Jul. 6, 2005 (JP) 2005-197865

(51) Int. Cl. G06F 3/00

(52) U.S. Cl. 710/60

(57) ABSTRACT

A computation unit computes an elapse time until second data stored in a storage unit is outputted since first data is stored in the storage unit. An output request unit changes a speed at which an output unit outputs data based on the elapse time.

### TECHNICAL FIELD

The present invention relates to an output circuit, a control program product, and a control method, particularly to the output circuit, control program product, and control method for dealing with data received through a communication network.

### BACKGROUND ART

Recently, in an in-home network, a technique of transferring real-time data such as AV data by an IP (Internet Protocol) packet is being grown. In such cases, a difference between an amount of data transferred per unit time and an amount of data reproduced per unit time is generated due to a time lag of clocks between an encoder (encoding circuit) and a decoder (decoding circuit), which possibly results in a problem such as degradation of image quality.

As shown in FIG. 30, in MPEG2-TS usually used in digital data real-time stream transmission, a synchronous signal called PCR signal is transmitted along with the data from a transmitter 1201 to a receiver 1202. In the decoder of receiver 1202, using a circuit called PLL circuit which performs synchronization of clocks, the clock of the encoder of transmitter 1201 is reproduced based on information on a value included in the PCR signal and time at which the PCR signal is inputted, which eliminates the time lag of clocks between transmitter 1201 and receiver 1202.

Although the synchronization system in which the PLL circuit is used is an effective technique when a fluctuation (jitter) in delay is small in the network, the synchronization system is not the effective technique in the network such as the IP data communication network in which a large jitter is generated.

A method called adaptive clock is usually used to solve the problem. In the method called adaptive clock, as shown in FIG. 31, all the pieces of data are tentatively buffered on the side of a receiver 1302 before the received data is inputted to the decoder, and the data is inputted to the decoder in synchronization with a clock on the receiver side (usually the clock is different from the clock inside the decoder).

For example, a timing at which the received data is outputted based on the clock on the receiver side is determined by comparing a value of timing information (time stamp) added to each packet to a counter synchronized with the clock on the receiver side, which allows the decoder to be operated in synchronization with time information for driving the buffer of the receiver.

Therefore, a speed at which the data is transmitted to the decoder of receiver 1302 is different from a speed at which a transmitter 1301 transmits the data, so that the data in the receiving buffer is increased or decreased on a long-term basis.

Japanese Patent Laying-Open No. 2000-174742 (Patent Document 1) and Japanese Patent Laying-Open No. 2002-165148 (Patent Document 2) disclose a technique of preventing overflow (hereinafter also referred to as overrun) and underflow (hereinafter also referred to as underrun) of the receiving buffer.

In the technique disclosed in Japanese Patent Laying-Open No. 2002-165148 (Patent Document 2), the data accumulated in the buffer is monitored, a data output speed is increased when the number of bytes of the accumulated data or a difference in time stamp value between the leading data and last data in the buffer exceeds an upper limit, and the data output speed is decreased when the number of bytes or the difference in time stamp value falls below a lower limit, thereby preventing the generation of the overflow and underflow.

FIG. 32 is a timing chart illustrating a change in buffer amount of the receiving buffer when the number of bytes is monitored. Referring to FIG. 32, when the buffering of the received data is started, the buffer amount of the receiving buffer is increased at a constant speed. When the buffer amount reaches a reproduction start buffer amount, the data in the receiving buffer is outputted to the decoder. The buffer amount is decreased in the case where a speed at which the data is outputted from the receiving buffer (hereinafter also referred to as buffer output speed) is faster than a speed at which the data is inputted to the receiving buffer (hereinafter also referred to as buffer input speed). The underrun is generated when this state is left as it is. Therefore, the buffer output speed is decreased to a speed slower than the buffer input speed when the buffer amount reaches a lower limit for avoiding the underrun. The buffer amount is increased in the receiving buffer when the buffer output speed is decreased to a slower speed than the buffer input speed. Because the overrun is generated when this state is left as it is, the buffer output speed is increased to a speed faster than the buffer input speed when the buffer amount reaches an upper limit for avoiding the overrun. Thus, the overrun and underrun are avoided.

### Patent Document 1: Japanese Patent Laying-Open No. 2000-174742

### Patent Document 2: Japanese Patent Laying-Open No. 2002-165148

### DISCLOSURE OF THE INVENTION

### Problems to be Solved by the Invention

In the conventional technique, as described above, the number of bytes of the data buffered in the buffer or the difference in value between the pieces of timing information added to the pieces of data is used to monitor the change in amount of data buffered in the receiving buffer.

On the other hand, in the digital data transmission, recently an attempt to transfer the encoded data and decode the encoded data immediately before the reproduction is made from the viewpoint of copyright protection. In the encoded data, the timing information added to the data pieces is also transferred in the encoded state.

In the case where the encoded data including the encoded timing information is received, in order to monitor the change in buffer amount with the difference between the values of the pieces of timing information, it is necessary that the encoded data be tentatively decoded to perform the buffering. However, because it is highly possible that the data on the buffer is obtained through an unintended method, the process of tentatively decoding the encoded data is undesirable from the viewpoint of copyright protection.

Additionally, the processing speed is limited in the decode process. When the data is received in a burst manner beyond the processing speed of the decode process, it is necessary to provide another buffer memory before the decode process, which results in a problem of cost increase.

Even if the timing information is encoded, the use of the timing information in the data is not required when the number of bytes accumulated in the buffer is utilized. However, the number of bytes accumulated in the buffer is momentarily changed in a VBR (Variable Bit Rate) transmission in which a transfer speed fluctuates as time advances. Therefore, in the VBR transmission, accurate control cannot be performed even if the change in buffer amount is monitored to control the data output based on the difference between the buffer output speed and the buffer input speed. As a result, the overrun or underrun is generated and the data cannot accurately be restored.

In view of the foregoing, an object of the present invention is to provide an output circuit capable of outputting data at correct timing.

Another object of the present invention is to provide a program product or a program capable of outputting data at correct timing.

Still another object of the present invention is to provide a control method capable of outputting data at correct timing.

### Means for Solving the Problems

In order to solve the foregoing problems, an output circuit in accordance with one aspect of the present invention includes: a storage unit to store data; an accumulation unit to store the data in the storage unit; an output request unit to provide an output request for the data stored in the storage unit; an output unit to output the data stored in the storage unit in response to the output request; and a computation unit to compute an elapse time until the output unit outputs second data stored in the storage unit since the accumulation unit stores first data in the storage unit, wherein the output request unit changes a speed at which the output unit outputs the data based on the elapse time.

Preferably, the output request unit increases the speed at which the output unit outputs the data when the elapse time reaches a predetermined upper limit, and the output request unit decreases the speed at which the output unit outputs the data when the elapse time reaches a predetermined lower limit.

Preferably, the computation unit computes a characteristic of the elapse time for a predetermined time by a predetermined calculation using predetermined pieces of information on the elapse time which is changed based on the data stored in the storage unit, and the output request unit changes the speed at which the output unit outputs the data based on the characteristic of the elapse time.

Preferably, the predetermined calculation is a calculation by a least-square method.

Preferably, the elapse time is a time period corresponding to a difference between time at which the accumulation unit stores the first data in the storage unit and time at which the output unit outputs the second data stored in the storage unit.

Preferably, the elapse time is a time period based on the number of clock counts counted until the output unit outputs the second data stored in the storage unit since the accumulation unit stores the first data in the storage unit.

Preferably, the first data and the second data are the same data.

Preferably, predetermined pieces of data are stored in the storage unit during a period until the second data is stored in the storage unit since the first data is stored in the storage unit.

An output circuit in accordance with another aspect of the present invention includes: a storage unit to store data; an accumulation unit to store encrypted data in the storage unit; an output request unit to provide an output request for the encrypted data stored in the storage unit; a first output unit to output the encrypted data from the storage unit in response to the output request; a decryption unit to decrypt the encrypted data outputted from the first output unit; a second output unit to output the decrypted data decrypted by the decryption unit; and a computation unit to compute an elapse time until the first output unit outputs second encrypted data stored in the storage unit since the accumulation unit stores first encrypted data in the storage unit, wherein the second output unit changes a speed at which the decrypted data is outputted based on the elapse time.

Preferably, the second output unit increases the speed at which the decrypted data is outputted when the elapse time reaches a predetermined upper limit, and the second output unit decreases the speed at which the decrypted data is outputted when the elapse time reaches a predetermined lower limit.

Preferably, the computation unit computes a characteristic of the elapse time for a predetermined time by a predetermined calculation using predetermined pieces of information on the elapse time which is changed based on the encrypted data stored in the storage unit, and the second output unit changes the speed at which the decrypted data is outputted based on the characteristic of the elapse time.

Preferably, the predetermined calculation is a calculation by a least-square method.

Preferably, the first encrypted data and the second encrypted data are the same data.

An output circuit in accordance with yet another aspect of the present invention includes: a storage unit to store data; an accumulation unit to store encrypted data in the storage unit; a first output unit to output the encrypted data from the storage unit; a decryption unit to decrypt the encrypted data outputted from the first output unit; a second output unit to output the decrypted data decrypted by the decryption unit in response to an output request; an output request unit to provide the output request to the second output unit; and a computation unit to compute an elapse time until the first output unit outputs second encrypted data stored in the storage unit since the accumulation unit stores first encrypted data in the storage unit, wherein the output request unit changes a speed at which the second output unit outputs the decrypted data based on the elapse time.

Preferably, the output request unit increases the speed at which the second output unit outputs the decrypted data when the elapse time reaches a predetermined upper limit, and the output request unit decreases the speed at which the second output unit outputs the decrypted data when the elapse time reaches a predetermined lower limit.

Preferably, the computation unit computes a characteristic of the elapse time for a predetermined time by a predetermined calculation using predetermined pieces of information on the elapse time which is changed based on the encrypted data stored in the storage unit, and the output request unit changes the speed at which the second output unit outputs the decrypted data based on the characteristic of the elapse time.

Preferably, the predetermined calculation is a calculation by a least-square method.

Preferably, the first encrypted data and the second encrypted data are the same data.

In accordance with yet another aspect of the present invention, an output circuit outputs data in response to an output request from an external circuit, and the output circuit includes: a storage unit to store data; an accumulation unit to store the data in the storage unit; an output unit to output the data stored in the storage unit in response to the output request; and a computation unit to compute an elapse time until the output unit outputs second data stored in the storage unit since the accumulation unit stores first data in the storage unit, and to notify the external circuit of the elapse time as information for controlling timing of the output request.

Preferably, the elapse time is a time period corresponding to a difference between time at which the accumulation unit stores the first data in the storage unit and time at which the output unit outputs the second data stored in the storage unit.

Preferably, the elapse time is a time period based on the number of clock counts counted until the output unit outputs the second data stored in the storage unit since the accumulation unit stores the first data in the storage unit.

Preferably, the first data and the second data are the same data.

Preferably, predetermined pieces of data are stored in the storage unit during a period until the second data is stored in the storage unit since the first data is stored in the storage unit.

In accordance with yet another aspect of the present invention, an output circuit outputs data in response to an output request from an external circuit, and the output circuit includes: a storage unit to store data; an accumulation unit to store the data in the storage unit; an output unit to output the data stored in the storage unit in response to the output request; and a notification unit to notify the external circuit of time at which the accumulation unit stores first data in the storage unit and time at which the output unit outputs second data stored in the storage unit as information for controlling timing of the output request.

Preferably, the first data and the second data are the same data.

In accordance with yet another aspect of the present invention, a control program product causes a computer to perform data processing, and the control program product causes the computer to execute the steps of: storing data in a storage unit of the computer; providing an output request for the data stored in the storage unit; outputting the data stored in the storage unit in response to the output request; computing an elapse time until second data stored in the storage unit is outputted since first data is stored in the storage unit; and changing a speed at which the data is outputted based on the elapse time.

Preferably, the first data and the second data are the same data.

In accordance with yet another aspect of the present invention, there is provided a control method performed by an output circuit provided with a storage unit, the control method including the steps of: storing data in a storage unit; providing an output request for the data stored in the storage unit; outputting the data stored in the storage unit in response to the output request; computing an elapse time until second data stored in the storage unit is outputted since first data is stored in the storage unit; and changing a speed at which the data is outputted based on the elapse time.

Preferably, the first data and the second data are the same data.

### EFFECTS OF THE INVENTION

In the output circuit according to the present invention, the speed at which the data is outputted is changed based on the elapse time until the second data stored in the storage unit is outputted since the first data is stored in the storage unit.

Accordingly, the data can be outputted at correct timing.

In the output circuit according to the present invention, the speed at which the data is outputted is changed based on the elapse time until the second encrypted data stored in the storage unit is outputted since the first encrypted data is stored in the storage unit.

Accordingly, the data can be outputted at correct timing.

In the output circuit according to the present invention, the speed at which the data is outputted is changed based on the elapse time until the second encrypted data stored in the storage unit is outputted since the first encrypted data is stored in the storage unit.

Accordingly, the data can be outputted at correct timing.

In the output circuit according to the present invention, on the basis of the elapse time until the second data stored in the storage unit is outputted since the first data is stored in the storage unit, the external circuit is notified of the elapse time as the information for controlling the timing at which the external circuit provides the output request. The output circuit outputs the data in response to the output request from the external circuit.

Accordingly, the data can be outputted at correct timing.

In the output circuit according to the present invention, the external circuit is notified of the time at which the first data is stored in the storage unit and the time at which the second data stored in the storage unit is outputted as the information for controlling the timing at which the external circuit provides the output request. The output circuit outputs the data in response to the output request from the external circuit.

Accordingly, the data can be outputted at correct timing.

In the program product according to the present invention, the speed at which the data is outputted is changed based on the elapse time until the second data stored in the storage unit is outputted since the first data is stored in the storage unit.

Accordingly, the data can be outputted at correct timing.

In the control method according to the present invention, the speed at which the data is outputted is changed based on the elapse time until the second data stored in the storage unit is outputted since the first data is stored in the storage unit.

Accordingly, the data can be outputted at correct timing.

### BRIEF DESCRIPTION OF THE DRAWINGS

FIG. 1 is a schematic diagram showing a configuration of a network system according to a present embodiment.

FIG. 2 is a block diagram showing internal configurations of a transmitter and a receiver of a first embodiment.

FIG. 3A is a diagram showing a configuration of streaming data by way of example.

FIG. 3B is a diagram showing a configuration of streaming data by way of example.

FIG. 4 is a diagram showing a process performed in a processing unit of the first embodiment.

FIG. 5 is a flowchart of a data accumulation process.

FIG. 6 is a diagram showing a state in which a packet is stored in a storage unit.

FIG. 7 is a flowchart of a difference monitoring process.

FIG. 8 is a diagram showing an example in which a storage address and a storage time are correlated to each other.

FIG. 9 is a diagram showing an example in which the storage address, the storage time, and an output time are correlated to one another.

FIG. 10 is a block diagram showing internal configurations of a transmitter and a receiver according to a second embodiment.

FIG. 11 is a diagram showing processes performed in a communication unit and a processing unit of the second embodiment.

FIG. 12 is a flowchart of a data receiving process.

FIG. 13 is a flowchart of a clock counting process.

FIG. 14 is a flowchart of an output request process.

FIG. 15 is a flowchart of a data output process.

FIG. 16 is a block diagram showing internal configurations of a transmitter and a receiver according to a third embodiment.

FIG. 17 is a diagram showing processes performed in a communication unit and a processing unit of the third embodiment.

FIG. 18 is a flowchart of a difference monitoring process A.

FIG. 19 is a flowchart of an output request process A.

FIG. 20 is a flowchart of a decryption process.

FIG. 21 is a flowchart of a data output process B.

FIG. 22 is a block diagram showing internal configurations of a transmitter and a receiver according to a fourth embodiment.

FIG. 23 is a diagram showing processes performed in a communication unit and a processing unit of the fourth embodiment.

FIG. 24 is a flowchart of a difference monitoring process B.

FIG. 25 is a flowchart of an output request process B.

FIG. 26 is a flowchart of a data output process C.

FIG. 27 is a flowchart of a data output process D.

FIG. 28 is a graph showing change in differential time as time advances.

FIG. 29 is a block diagram showing internal configurations of a transmitter and a receiver according to a fifth embodiment.

FIG. 30 is a diagram showing a configuration of a conventional network system.

FIG. 31 is a diagram showing a configuration of another conventional network system.

FIG. 32 is a timing chart illustrating a change in buffer amount of a receiving buffer when the number of bytes is monitored.

### DESCRIPTION OF THE REFERENCE SIGNS

100 and 100B transmitter, 200, 200A, 200B, and 200C receiver, 210 decoder, 230 communication unit, 240, 240A, 240B, and 240C output circuit, 250 and 250B processing unit, 244, 245, 248A, and 248B storage unit, 300 storage medium, 310 control program, 1000 network system

### BEST MODES FOR CARRYING OUT THE INVENTION

Preferred embodiments of the present invention will be described below with reference to the drawings. In the following description, because the same component is designated by the same numeral and has the same name and function, the detailed description of the same component is not repeated.

Example of MPEG2-TS real-time stream transmission with RTP (Real Time Protocol) through an IP (Internet Protocol) network will be described in the following embodiments of the present invention. However, the present invention is not limited to the embodiments.

### First Embodiment

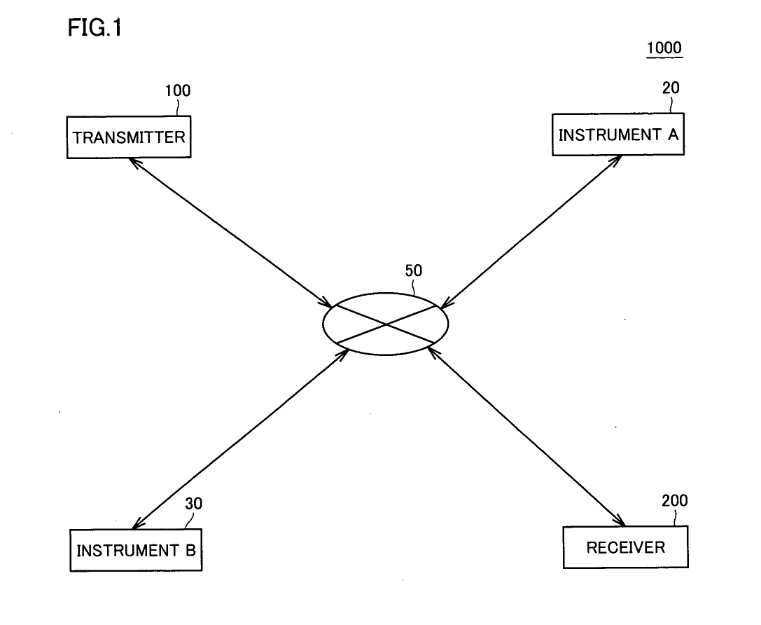

FIG. 1 is a schematic diagram showing a configuration of a network system 1000 according to a present embodiment. Network system 1000 is one to which various in-home instruments such as a television set, a hard disk recorder (hereinafter also referred to as HDR), and a digital tuner are connected. In network system 1000, communication is performed using a network protocol such as IP.

Referring to FIG. 1, network system 1000 includes a transmitter 100, a receiver 200, an instrument 20, an instrument 30, and a network 50.

For example, network 50 is a network such as the Internet. Transmitter 100, receiver 200, instrument 20, and instrument 30 are connected to network 50.

Transmitter 100 performs the real-time stream transmission with receiver 200 through network 50.

Instruments such as a video cassette recorder, an HDR, and a digital tuner may be used as transmitter 100 as long as the instrument has a communication function capable of transmitting image data.

Receiver 200 has a function of receiving real-time data transmitted from transmitter 100 through network 50. Instruments such as a television set and a liquid crystal projector may be used as receiver 200 as long as the instrument has a communication function capable of receiving image data.

Instruments 20 and 30 are other instruments connected to network 50.

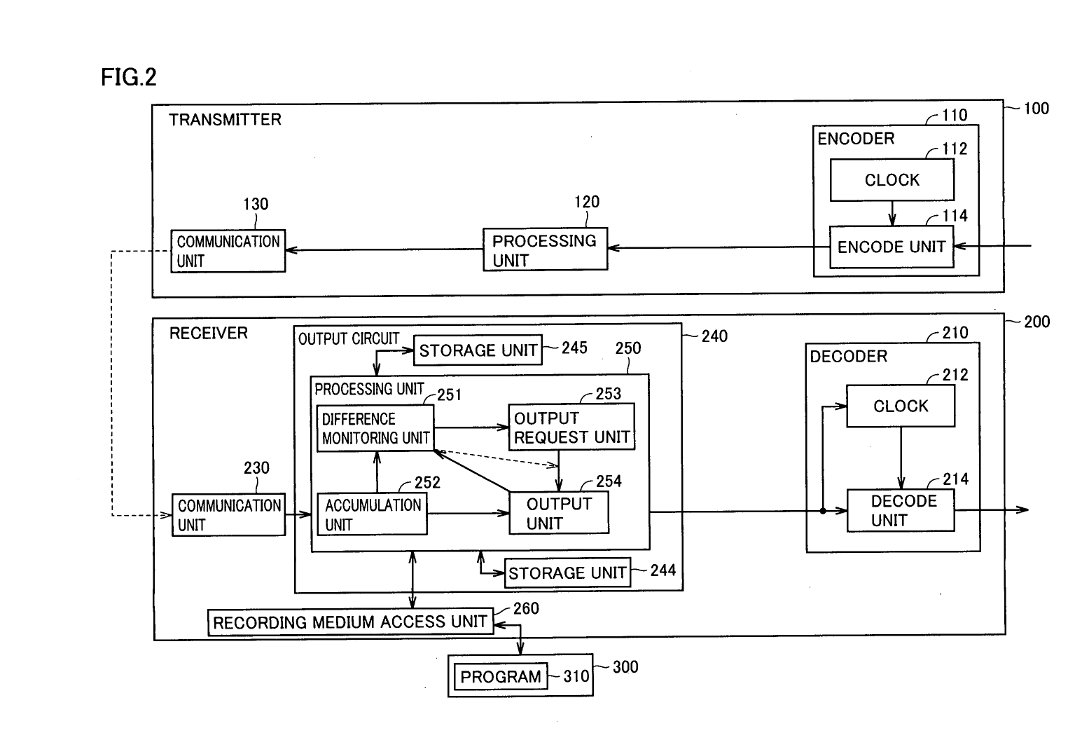

FIG. 2 is a block diagram showing internal configurations of transmitter 100 and receiver 200 of the first embodiment. For the sake of explanation, a recording medium 300 is also shown in FIG. 1. A control program 310 to be described later is recorded in recording medium 300. That is, control program 310 is recorded in a medium or the like and distributed as a program product. Recording medium 300 is also distributed as a program product.

Referring to FIG. 2, transmitter 100 includes an encoder 110, a processing unit 120, and a communication unit 130.

Encoder 110 has functions of encoding an inputted image signal and outputting data after encoding. Encoder 110 includes a clock 112 and encode unit 114. Encode unit 114 encodes the inputted image signal according to a predetermined encoding method, and outputs data (hereinafter also referred to as encoded data) after the encoding. At this point, it is assumed that MPEG2 is the predetermined encoding method. Clock 112 counts a encoding time necessary for the encoding.

Examples of processing unit 120 include a microprocessor, an FPGA (Field Programmable Gate Array) which is a programmable LSI (Large Scale Integration), an ASIC (Application Specific Integrated Circuit) which is an integrated circuit designed and produced for a specific application, and other circuits having computation functions.

Processing unit 120 sequentially converts the encoded data outputted from encode unit 114 into data (hereinafter also referred to as streaming data) in a format capable of being transferred on the network, and sequentially outputs the streaming data to communication unit 130. The streaming data is a packet.

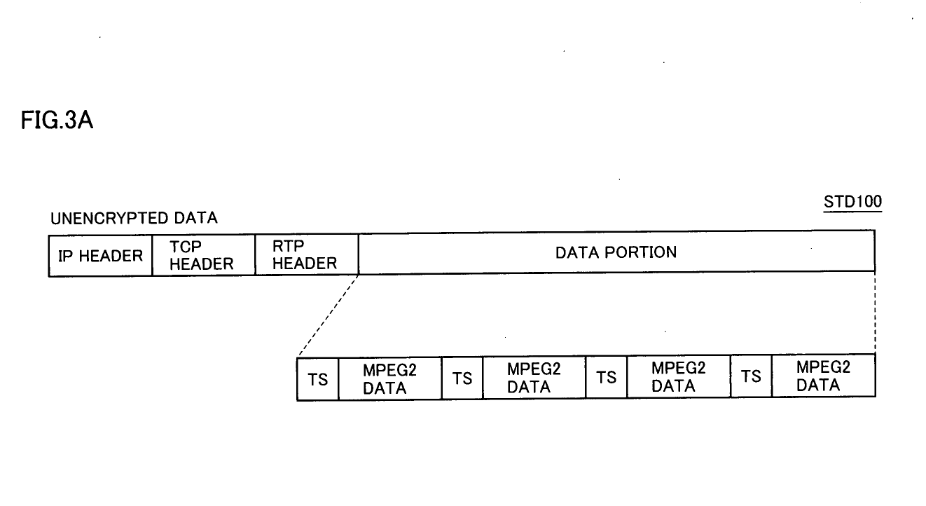

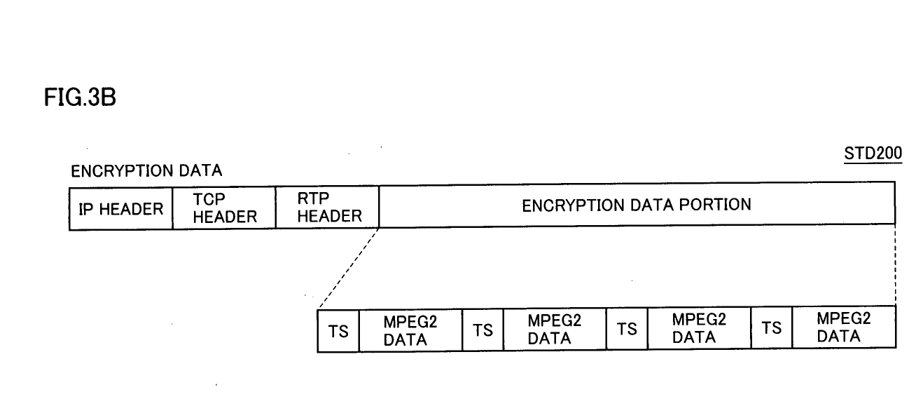

FIG. 3A is a diagram showing a configuration of streaming data STD 100 by way of example. Referring to FIG. 3A, streaming data STD100 includes an IP header, a TCP (Transmission Control Protocol) header, an RTP header, and a data portion. In the data portion, predetermined pieces of data to which time stamps (hereinafter also referred to as TS) are added to MPEG2 data as the encoded data are collected. The MPEG2 data is encoded at a variable bit rate. Accordingly, the image data and audio data in the MPEG2 data are also the data encoded at the variable bit rate. The time stamp (TS) indicates a timing which the corresponding MPEG2 data is outputted to decoder 210 of receiver 200.

FIG. 3B is a diagram showing a configuration of streaming data STD 200 by way of example. Streaming data STD 200 differs from streaming data STD100 in that streaming data STD 200 includes an encryption data portion instead of the data portion. Other configurations of streaming data STD 200 are similar to those of streaming data STD100, so that the detailed description is not repeated. The encryption data portion is data in which the data portion of streaming data STD100 is encrypted by a predetermined method.

In the present embodiment, the streaming data transmitted from transmitter 100 to receiver 200 is either streaming data STD100 or streaming data STD 200.

Referring to FIG. 2 again, communication unit 130 sequentially transmits the streaming data as packets sequentially generated by processing unit 120 to network 50. Communication unit 130 is e.g. a communication interface in which Ethernet (registered trademark) is utilized.

Receiver 200 receives the streaming data as the packets sequentially transmitted from transmitter 100.

Receiver 200 includes a communication unit 230, an output circuit 240, a recording medium access unit 260, and a decoder 210.

Communication unit 230 has a function of receiving the data sequentially transmitted from transmitter 100 through network 50. Communication unit 230 is an interface similar to communication unit 130, so that the detailed description is not repeated.

Output circuit 240 includes a processing unit 250, a storage unit 244, and a storage unit 245. Storage unit 244 acts as a FIFO (First In First Out) type buffer capable of tentatively retaining data. Storage unit 245 is a memory capable of retaining data. A control program 310 for causing processing unit 250 to perform the later-described processes, various programs, and various pieces of data are stored in storage unit 245. Processing unit 250 performs data access to storage units 244 and 245.

Processing unit 250 is a circuit having a similar function to that of the processing unit 120, so that the detailed description is not repeated. Processing unit 250 has functions of performing various processes to each instrument in receiver 200, a computation process, and the like according to control program 310 stored in storage unit 245.

Processing unit 250 includes a difference monitoring unit 251, an accumulation unit 252, an output request unit 253, and an output unit 254. The functions of processing unit 250 are shared by difference monitoring unit 251, accumulation unit 252, output request unit 253, and output unit 254 which perform the later-described processes. A processing unit provided separately from processing unit 250 may include output request unit 253 and output unit 254. All or part of the units included in processing unit 250 may be configured by hardware.

Output request unit 253 provides an output request at a predetermined timing to output unit 254 to output the data stored in storage unit 244. Output unit 254 outputs the data stored in storage unit 244 to decoder 210 in response to the output request from output request unit 253.

Decoder 210 has a function of decoding the received data. Decoder 210 includes a clock 212 and a decode unit 214.

Recording medium access unit 260 has a function of reading control program 310 from recording medium 300 in which control program 310 is recorded. Control program 310 stored in recording medium 300 is read by an operation (install process) of processing unit 250 from recording medium access unit 260 and stored in storage unit 245.

The install processing program is previously stored in storage unit 245, and processing unit 250 performs the install process based on an install processing program.

Control program 310 may not be installed in storage unit 245. In this case, processing unit 250 reads control program 310 stored in recording medium 300 through recording medium access unit 260, and performs a predetermined process based on control program 310.

Examples of recording medium 300 include a DVD-ROM (Digital Versatile Disk Read Only Memory), a DVD-R (Digital Versatile Disk Recordable), a DVD-RAM (Digital Versatile Disk Random Access Memory), a DVD+RW (Digital Versatile Disk Re-Writable), a DVD-RW, a CD-ROM (Compact Disk Read Only Memory), an MO (Magneto Optical Disk), a Floppy (registered trademark) disk, a CF (Compact Flash) card, an SM (Smart Media (registered trademark)), an MMC (Multi Media Card), an SD (Secure Digital) memory card, a MEMORY STICK (registered trademark), an xD picture card, a USB memory, a magnetic tape, a hard disk and other nonvolatile memories.

Receiver 200 can perform a program download process through communication unit 230 from network 50 to store the program in storage unit 245. In this case, the downloaded program is control program 310.

Processing unit 250 performs a predetermined process according to the program (control program 310) downloaded from network 50. A downloading program is previously stored in storage unit 245, and processing unit 250 performs the download process based on the downloading program.

Decode unit 214 decodes the MPEG2 data outputted from output unit 254.

Clock 212 generates a clock to reproduce the received data based on both time information on the time stamp (TS) included in the data outputted from output unit 254 and the timing at which the data is inputted to decoder 210. Clock 212 includes a circuit called PLL (Phase Locked Loop). Decode unit 214 reproduces images and sounds based on the timing at which the clock is generated by clock 212.

In the present embodiment, various processes described below are simultaneously started and independently performed.

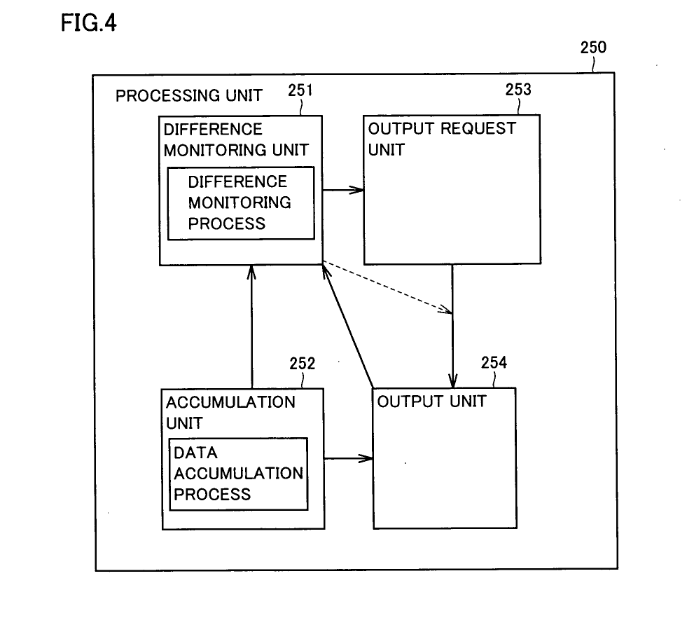

FIG. 4 is a diagram showing a process performed in processing unit 250 of the first embodiment. Referring to FIG. 4, accumulation unit 252 performs a data accumulation process. Accumulation unit 252 manages current time at all times. For example, the time at which a certain process is performed in the data accumulation process is shown as seconds that have elapsed from the start of the data accumulation process. Upon the start of the data accumulation process by accumulation unit 252, difference monitoring unit 251 starts a difference monitoring process to be described later. Difference monitoring unit 251 manages the time managed by accumulation unit 252. For example, the time at which a certain process is performed in the difference monitoring process is shown as seconds that have elapsed from the start of the data accumulation process (difference monitoring process).

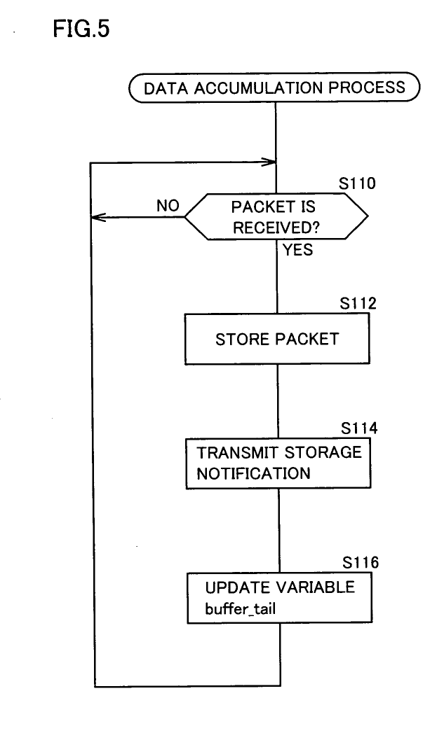

FIG. 5 is a flowchart of the data accumulation process. Referring to FIG. 5, in step S110, accumulation unit 252 determines whether or not the packet has been received. If YES in step S110, the procedure proceeds to step S112. On the other hand, if NO in step S110, the process in step S110 is repeated.

In step S112, accumulation unit 252 stores the received packet in storage unit 244.

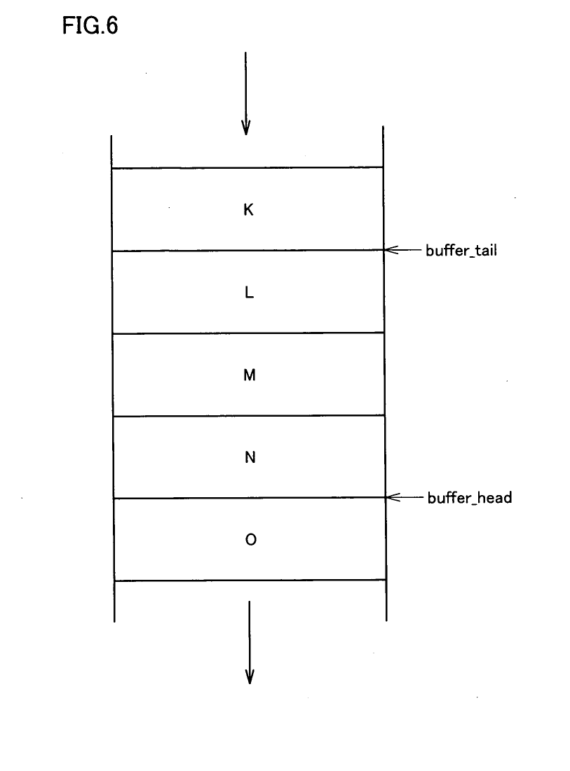

FIG. 6 is a diagram showing a state in which the packet is stored in storage unit 244. Referring to FIG. 6, buffer_tail is a variable indicating an address of a region where the new data is stored in storage unit 244. The variable buffer_tail indicates a leading address at which the data is not stored in storage unit 244. In FIG. 6, the pieces of data are stored in regions O, N, and M, and the pieces of data are not stored in regions L and K. In this case, the variable buffer_tail indicates an address of the region L.

The pieces of data newly stored in storage unit 244 are stored with the region having the address indicated by the variable buffer_tail in the lead. Accordingly, in the process in step S112, the packet is stored in the region L of storage unit 244. The pieces of data are stored in the regions L and K in the case where a size of the data to be stored in storage unit 244 is larger than the region L.

Referring to FIG. 5, when the process in step S112 is ended, the procedure proceeds to step S114.

In step S114, accumulation unit 252 transmits a storage notification that the packet is already stored to difference monitoring unit 251. The storage notification includes a value of the variable buffer_tail indicating the leading address where the packet is stored. The storage notification also includes information on the time (hereinafter also referred to as storage time) at which the packet is stored. Then, the procedure proceeds to step S116.

In step S116, accumulation unit 252 increases the value of the variable buffer_tail by the number of bytes of the data stored in the process in step S112, which changes a position where the next packet is to be written. Then, the process in step S110 is performed again.

Referring to FIG. 4, difference monitoring unit 251 performs the difference monitoring process.

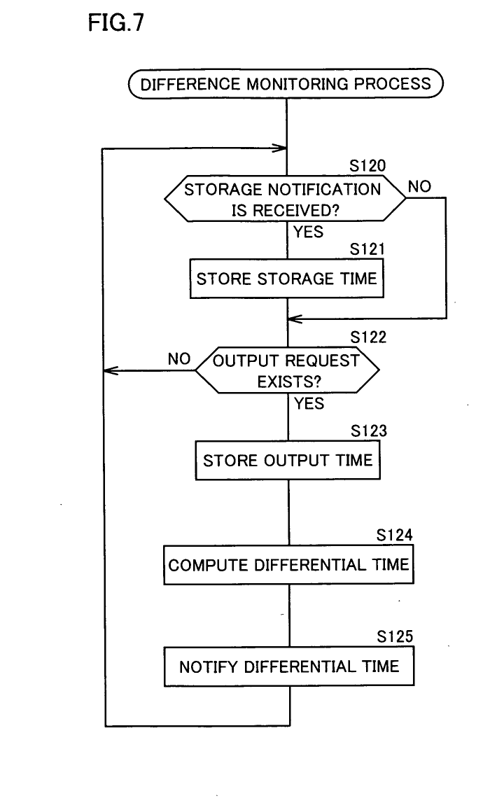

FIG. 7 is a flowchart of the difference monitoring process. Referring to FIG. 7, in step S120, difference monitoring unit 251 determines whether or not the storage notification has been received from accumulation unit 252. If YES in step S120, the procedure proceeds to step S121. On the other hand, if NO in step S120, the procedure proceeds to step S122.

In step S121, on the basis of the received storage notification, difference monitoring unit 251 stores the value of the variable buffer_tail and information on the storage time included in the storage notification in storage unit 245 while the value of the variable buffer_tail and information on the storage time are correlated with each other. In this case, the value of the variable buffer_tail indicates the leading address (hereinafter also referred to as storage address) of the address where the packet is stored.

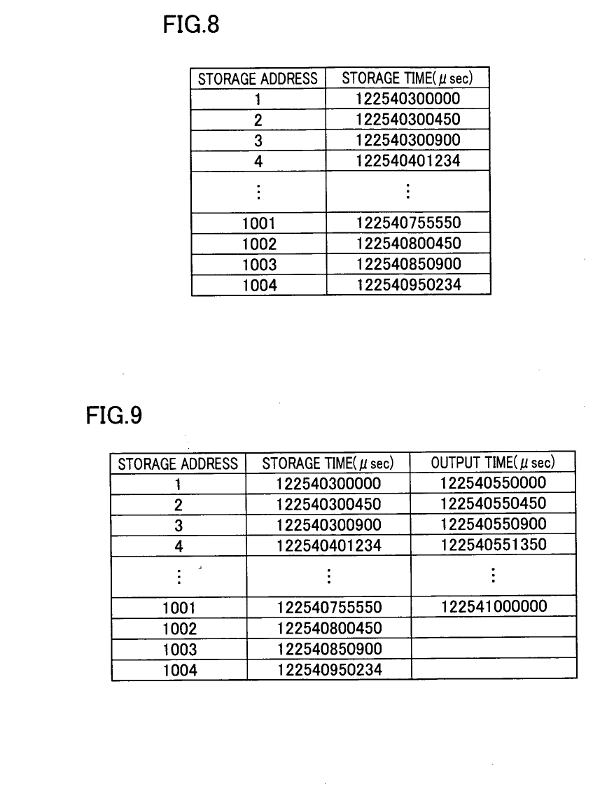

FIG. 8 is a diagram showing an example in which the storage address and the storage time are correlated to each other. Referring to FIG. 8, it can be seen that the time at which the data is stored at a storage address “1” of storage unit 245 is the time when 122540300000 μs have elapsed since the start of the above-described data accumulation process.

Referring to FIG. 7 again, when the process in step S121 is ended, the procedure proceeds to step S122.

In step S122, difference monitoring unit 251 determines whether or not output request unit 253 has provided the output request to output unit 254. The output request includes the address (storage address) of storage unit 244 from which the data shall be read. When output unit 254 receives the output request, output unit 254 reads from storage unit 244 the data whose address is specified in storage unit 244 and outputs the data to decoder 210. If YES in step S122, the procedure proceeds to step S123. On the other hand, if NO in step S122, the process in step S120 is performed again.

In step S123, difference monitoring unit 251 stores time (hereinafter also referred to as output time) at which the output request is provided in storage unit 245 while the output time is correlated with the storage address included in the output request. That is, the data correlated with the storage address, storage time, and output time is stored in storage unit 245.

FIG. 9 is a diagram showing an example in which the storage address, the storage time, and the output time are correlated to one another. Referring to FIG. 9, it can be seen that the time at which the data having the storage address “1” of storage unit 245 is outputted is the time when 122540550000 μs have elapsed since the start of the above-described data accumulation process (difference monitoring process).

Referring to FIG. 7 again, when the process in step S123 is ended, the procedure proceeds to step S124.

In step S124, difference monitoring unit 251 computes a time period corresponding to a difference between the output time stored in the process in step S123 and the storage time corresponding to the output time. For example, in FIG. 9, it is assumed that the output time “122541000000” is stored while correlated with the storage address “1001”. In this case, the time period corresponding to the difference is 122541000000−122540755550=244450 (μs). Hereinafter the time corresponding to the difference is also referred to as differential time. The differential time is a time period which indicates how long storage unit 244 has retained the data stored at the storage address “1001” thereof. In this case, the differential time corresponds to a time period during which the data stored in storage unit 244 is outputted and reproduced by decoder 210 during a period between the time at which the data is stored at storage address “1001” of storage unit 244 and the time before 244450 μs elapses.

As described above, the differential time indicates the time period as to how long storage unit 244 has retained the data stored therein. That is, the differential time also indicates an elapse time until the data is outputted since the data is stored in storage unit 244. Therefore, hereinafter the differential time is also referred to as elapse time. Then, the procedure proceeds to step S125.

In step S125, difference monitoring unit 251 notifies output request unit 253 of the information on the computed differential time. Then, the process in step S120 is performed again.

Although shown in detail later, output request unit 253 has a function of determining the timing of the output of the data stored in storage unit 244. Output request unit 253 monitors how the differential time changes as time advances. The increase in differential time as time advances shows that an amount of data stored in storage unit 244 is increased as time advances.

This is a phenomenon caused by a delay in the timing of the output request provided from output request unit 253 relative to the data transmission from transmitter 100. In this case, output request unit 253 quickens the timing of the output request. On the other hand, when the differential time is decreased as time advances, the timing of the output request provided from output request unit 253 is faster. In this case, output request unit 253 slows the timing of the output request. Although described in detail later, output request unit 253 determines that the differential time is increased when the differential time exceeds a predetermined upper limit, and output request unit 253 determines that the differential time is decreased when the differential time falls below a predetermined lower limit.

As described above, output circuit 240 of the first embodiment utilizes the differential time of the data without using the number of bytes of the data stored in storage unit 244 (buffer) or the value of the time stamp added to the packet. Output request unit 253 determines the timing of the data output according to the differential time.

Accordingly, even in the data compressed at a variable bit rate with which a data transfer rate changes or the encrypted data whose time stamp cannot be referred to, output request unit 253 can provide the output request to output unit 254 at correct timing. Therefore, output unit 254 can output the data stored in storage unit 244 at correct timing. That is, advantageously the data can be outputted at correct timing.

Although described in detail later, the differential time is also used to detect a time lag in operation clock between the receiver and the transmitter.

### Second Embodiment

An output circuit as one mode of the present invention will be described in detail. The mode in which the output circuit is incorporated into the receiver in the real-time stream transmission will be described by way of example.

A network system according to the present embodiment differs from network system 1000 in that a receiver 200A is included instead of receiver 200. Because other configurations are similar to those of network system 1000, the detailed description is not repeated.

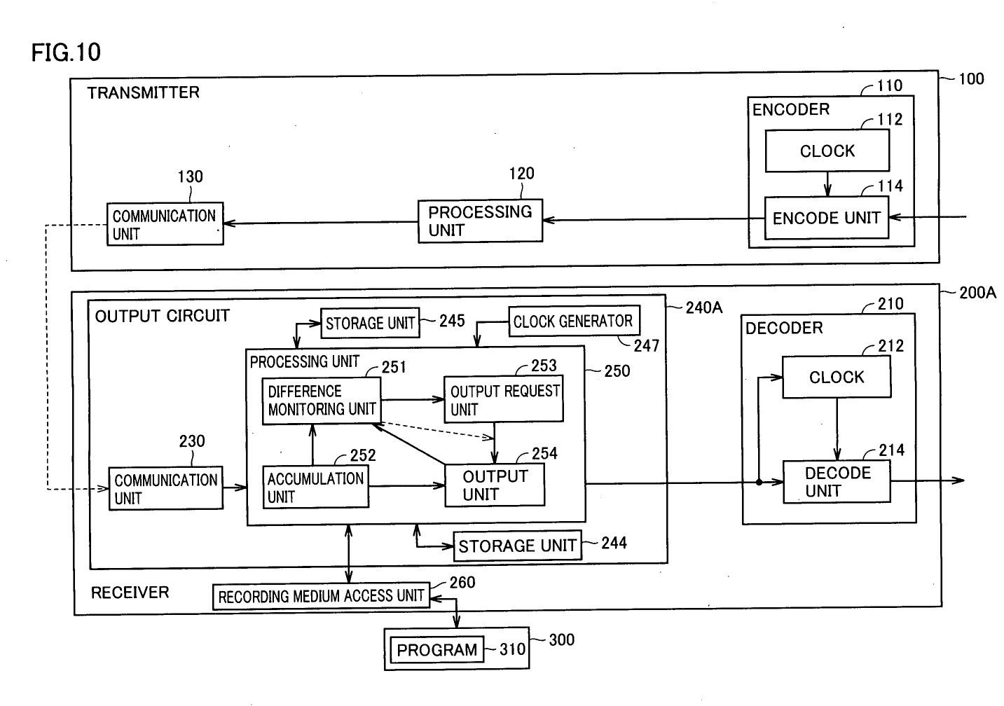

FIG. 10 is a block diagram showing internal configurations of transmitter 100 and receiver 200A according to a second embodiment. Referring to FIG. 10, receiver 200A differs from receiver 200 in that not only receiver 200A does not include communication unit 230 but also receiver 200A includes an output circuit 240A instead of output circuit 240. Because other configurations are similar to those of receiver 200, the detailed description is not repeated.

Output circuit 240A differs from output circuit 240 in that output circuit 240A further includes communication unit 230 and clock generator 247. Because other configurations are similar to those of output circuit 240, the detailed description is not repeated. Clock generator 247 transmits a reference clock to processing unit 250. As used herein, the reference clock shall mean a clock used to compute the elapse time from the start of the various processes described above or the various processes to be described later in the receiver.

Processing unit 250 is operated based on a clock different from the reference clock.

Receiver 200A receives streaming data as packets from transmitter 100 through network 50. The streaming data is streaming data STD100 (see FIG. 3A). In the present embodiment, various processes described below are simultaneously started and independently performed.

Each process performed in output circuit 240A will be described below with reference to a flowchart.

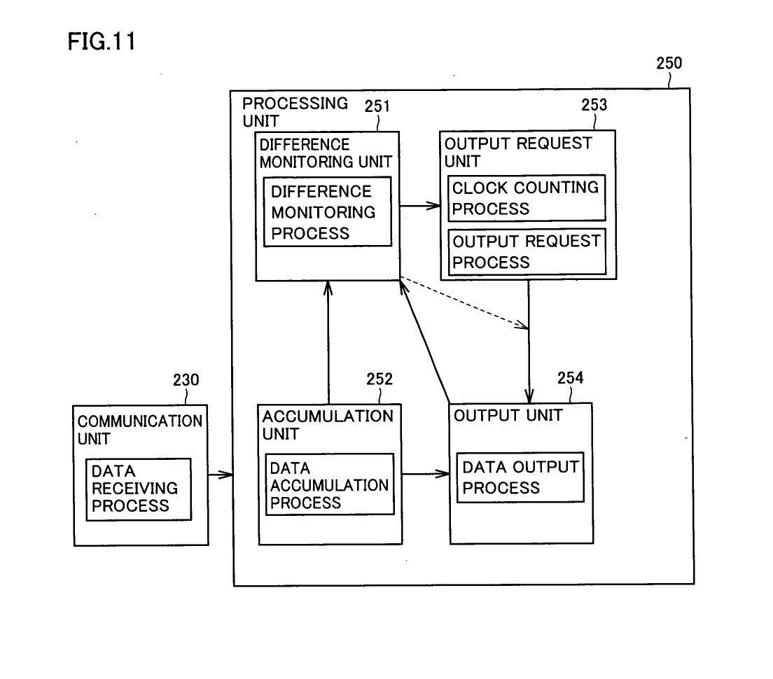

FIG. 11 is a diagram showing processes performed in communication unit 230 and processing unit 250 of the second embodiment. Referring to FIG. 11, communication unit 230 performs a data receiving process.

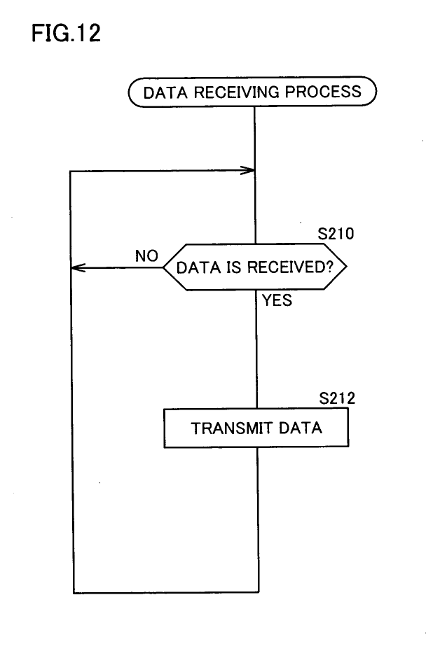

FIG. 12 is a flowchart of the data receiving process. Referring to FIG. 12, in step S210, communication unit 230 determines whether or not the data has been received. If YES in step S210, the procedure proceeds to step S212. On the other hand, if NO in step S210, the process in step S210 is performed again.

In step S212, communication unit 230 transmits the received data to accumulation unit 252. Then, the process in step S210 is performed again.

Referring to FIG. 11 again, accumulation unit 252 performs the above-described data accumulation process of FIG. 5. Difference monitoring unit 251 performs the above-described difference monitoring process of FIG. 7. Through the process in step S125 of the difference monitoring process, difference monitoring unit 251 notifies output request unit 253 of the information on the computed differential time.

Then, a process performed by output request unit 253 will be described. Output request unit 253 performs a clock counting process.

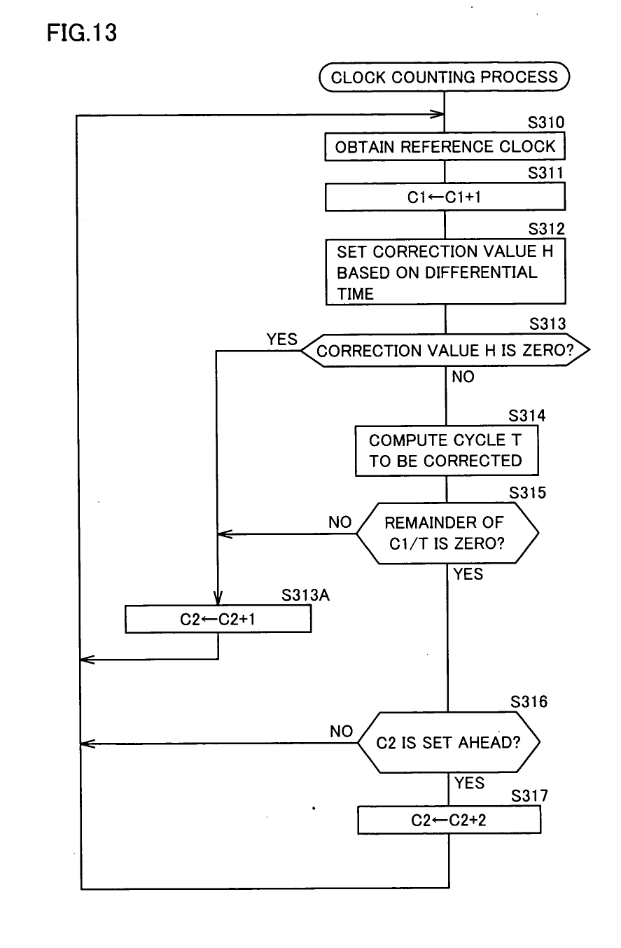

FIG. 13 is a flowchart of the clock counting process. Referring to FIG. 13, in step S310, output request unit 253 obtains the above-mentioned reference clock from clock generator 247. The processing unit 250 (output request unit 253) itself is operated at a frequency of the above-mentioned operation clock.

For example, in the case of the reference clock of 27 MHz, a time period (hereinafter also referred to as clock counting process time) until the time at which the process in step S310 is performed again since the time at which the process in step S310 is started is set within a cycle of the reference clock. In the case of the reference clock of 27 MHz, the cycle is 37 ns from 1/(27×10⁶). Accordingly, it is necessary that the clock counting process time be set to 37 ns or less. Then, the procedure proceeds to step S311.

In step S311, output request unit 253 increments a counter C1 by one. Counter C1 counts the number of times on which the reference clock is obtained. Counter C1 is provided in storage unit 245. An initial value of counter C1 is set to zero. Then, the procedure proceeds to step S312.

In step S312, setting of a correction value H is performed. Specifically, output request unit 253 sets correction value H of counter C1 per unit time based on the latest information in the pieces of information on the differential time sequentially notified from difference monitoring unit 251 by the above-described process in step S125 of FIG. 7.

Because the information on the differential time is sequentially notified from difference monitoring unit 251, the information used in the process in step S312 is set to the latest information on the differential time. The differential time is not always constant, and it fluctuates.

Correction value H of counter C1 is set to a predetermined value when the differential time becomes a predetermined upper limit or more or lower limit or less. Otherwise, correction value H determined in the previously performed process in step S312 is directly used as correction value H of counter C1.

The fact that the differential time becomes the predetermined upper limit or more shows that a speed at which the data is stored in storage unit 244 is faster than a speed at which the data is outputted from storage unit 244. That is, storage unit 244 will eventually generate overrun.

The fact that the differential time becomes the predetermined lower limit or less shows that the speed at which the data is stored in storage unit 244 is slower than the speed at which the data is outputted from storage unit 244. That is, storage unit 244 will eventually generate underrun. In order to prevent the phenomena, correction value H is set as follows.

In the present embodiment, in the case where the reference clock has the frequency of 27 MHz, it is assumed that the correction by e.g. 60 μs is required per second. In this case, 1620 is obtained from the computation of 27×10⁶×60×10⁻⁶. The computed value of 1620 is the number of clock counts corresponding to the correction value per second (unit time).

When the notified differential time is not less than the predetermined upper limit (for example, 400000 μs), correction value H is set to −1620. When the notified differential time is not more than the predetermined lower limit (for example, 200000 μs), correction value H is set to 1620. Then, the procedure proceeds to step S313.

In step S313, output request unit 253 determines whether or not set correction value H is zero. If YES in step S313, the flow goes to step S313A to be described later. On the other hand, if NO in step S313, the procedure proceeds to step S314.

A cycle T during which a counter C2 is corrected is computed in step S314. At this point, counter C2 is a counter for determining the timing of the output of data stored in storage unit 244. Counter C2 is provided in storage unit 245. An initial value of counter C2 is set to zero. Cycle T indicates that counter C2 is set ahead by one time relative to the number of reference clocks. Cycle T is computed by an equation of (count value counted by reference clock per unit time)/(the number of clock counts corresponding to correction value per unit time).

For example, in the case where the reference clock has a clock frequency of 27 MHz, it is assumed that the correction by e.g. 60 μs required per second. In this case, because 60 μs corresponds to 1620 clock counts by the above-described computation, 16666.66 . . . is obtained by the computation of T=27000000/1620.

In the present embodiment, the counter is set ahead by incrementing the value of counter C2 by two (although usually incrementing the value by one) at a rate of one time for 16666 reference clock obtaining times, or the value of counter C2 is not increased but left as it is. The progress of counter C2 can be changed through this process. That is, the timing of the output of data stored in storage unit 244 can be changed. Then, the procedure proceeds to step S315.

In step S315, output request unit 253 determines whether or not a remainder of the division of counter C1 by cycle T is zero. The remainder of zero shows that the current time reaches cycle T of the correction. The remainder of a value except zero shows that the current time does not reach cycle T of the correction. If YES in step S315, the procedure proceeds to step S316. On the other hand, if NO in step S315, the procedure proceeds to step S313A to be described later.

In step S316, output request unit 253 determines whether or not counter C2 is set ahead. That is, output request unit 253 determines whether counter C2 is set ahead or behind. The determination is made e.g. using a sign of correction value H per unit time set in step S312. When correction value H has the negative sign, output request unit 253 determines that counter C2 be set ahead, namely, output request unit 253 makes the clock count faster. When correction value H has the positive sign, output request unit 253 determines that counter C2 be set behind, namely, output request unit 253 makes the clock count slower.

If YES in step S316, the procedure proceeds to step S317. If NO in step S316, the process in step S310 is performed again. That is, if NO in step S316, the value of counter C2 is not increased by the reference clock obtained through the current process.

In step S317, output request unit 253 increments counter C2 by two. Then, the process in step S310 is performed again.

If YES in above-described step S313, or if NO in step S315, the procedure proceeds to step S313A.

In step S313A, output request unit 253 increments counter C2 by one. That is, counter C2 is incremented by one each time the reference clock is obtained. As a result, the count of the reference clock is not corrected by the reference clock obtained through the current process. Then, the process in step S310 is performed again.

Thus, in the clock counting process, the progress of counter C2 for determining the timing of the output of data stored in storage unit 244 is controlled based on the information on the differential time sequentially notified from difference monitoring unit 251.

Specifically, when the amount of data stored in storage unit 244 is not less than the predetermined upper limit, the progress of counter C2 is made faster. When the amount of data stored in storage unit 244 is not more than the predetermined lower limit, the progress of counter C2 is made slower. As described above, counter C2 is a counter for determining the timing of the output of data stored in storage unit 244. Therefore, the effect of preventing the generation of overrun or underrun in storage unit 244 is obtained through the above-described processes.

Referring to FIG. 11 again, output request unit 253 further performs an output request process. The clock counting process and the output request process are simultaneously started and independently performed.

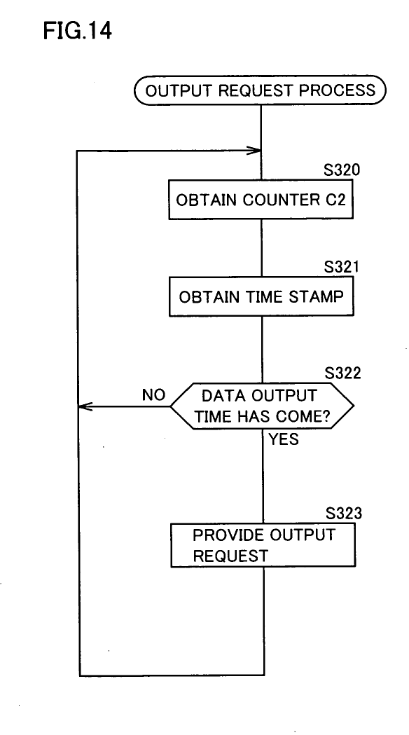

FIG. 14 is a flowchart of the output request process. Referring to FIG. 14, in step S320, output request unit 253 obtains the value of counter C2, which is updated as needed by the above-described clock counting process, by reading the value of counter C2 from storage unit 245. Then, the procedure proceeds to step S321.

In step S321, output request unit 253 reads the data having the oldest storage time in the plural pieces of data stored in storage unit 244. It is assumed that the read data is e.g. streaming data STD100 of FIG. 3A. Then, output request unit 253 obtains the time stamp (TS) of streaming data STD100. The time stamp (TS) is information indicating the time (timing) at which the data is reproduced. For example, the time is shown in the form of e.g. the output time in FIG. 9. Then, the procedure proceeds to step S322.

In step S322, whether or not the output time (timing) of the data has come is determined. Specifically, output request unit 253 determines whether or not the time indicated by the time stamp obtained in step S321 coincides with the value of counter C2 obtained in step S320. If YES in step S322, the procedure proceeds to step S323. On the other hand, if NO in step S322, the process in step S320 is performed again.

In step S323, output request unit 253 transmits the data output request to output unit 254. Then, the process in step S320 is performed again.

Then, a processing function of output unit 254 will be described.

Referring to FIG. 11 again, output unit 254 performs the data output process of outputting the data stored in storage unit 244 to decoder 210 according to the timing of the output request from output request unit 253.

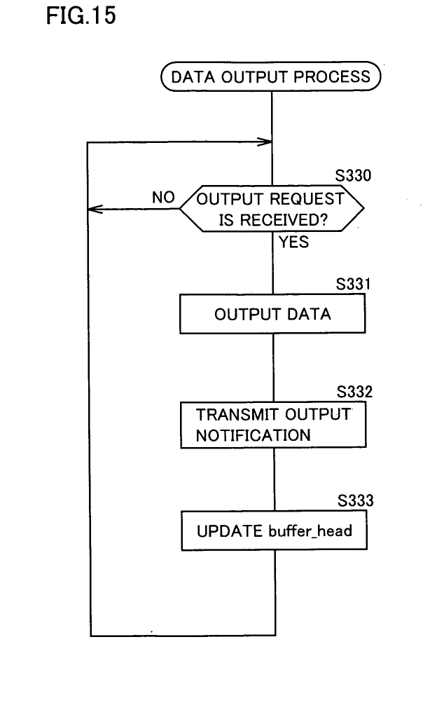

FIG. 15 is a flowchart of the data output process. Referring to FIG. 15, in step S330, output unit 254 determines whether or not the output request has been received from the output request unit 253. If YES in step S330, the procedure proceeds to step S331. On the other hand, if NO in step S330, the process in step S330 is performed again.

In step S331, output unit 254 refers to a value of a variable buffer_head (see FIG. 6) indicating the current data output position. The variable buffer_head is stored in storage unit 245. Output unit 254 reads the data with the storage address of storage unit 244 corresponding to the value of variable buffer_head referred to set to the leading address, and outputs (transmits) the data to decoder 210. Then, the procedure proceeds to step S332.

In step S332, output unit 254 transmits an output notification that the data has been outputted to decoder 210 to difference monitoring unit 251. The leading address (storage address) of storage unit 244 where the data is read is included in the output notification. Then, the procedure proceeds to step S333.

In step S333, output unit 254 increases the value of the variable buffer_head by the number of bytes of the data outputted through the process in step S331, which changes the output position of the next data (packet). Then, the process in step S330 is performed again.

As described above, in output circuit 240A of the second embodiment, the streaming data is received through network 50, the data is tentatively stored in storage unit 244, and output unit 254 outputs the tentatively-stored data to decoder 210.

The timing of the data output is dynamically controlled based on the differential time computed by difference monitoring unit 251. Therefore, the effect of preventing the generation of overrun or underrun in storage unit 244 is obtained.

The information on the differential time used to control the timing of the data output is independent of the number of bytes of the data stored in storage unit 244. Therefore, even if the number of bytes of the data stored in storage unit 244 fluctuates due to the fluctuation in bit rate like the VBR, output unit 254 can output the data stored in storage unit 244 to decoder 210 at correct timing. That is, the effect of outputting the data at correct timing is obtained.

### Third Embodiment

In a present embodiment, an output circuit as another mode of the present invention will be described in detail. The mode in which the output circuit is incorporated into the receiver in the real-time stream transmission will be described by way of example.

A network system of the present embodiment differs from network system 1000 in that the network system includes a transmitter 100B instead of transmitter 100 while including a receiver 200B instead of receiver 200. Because other configurations are similar to those of network system 1000, the detailed description is not repeated.

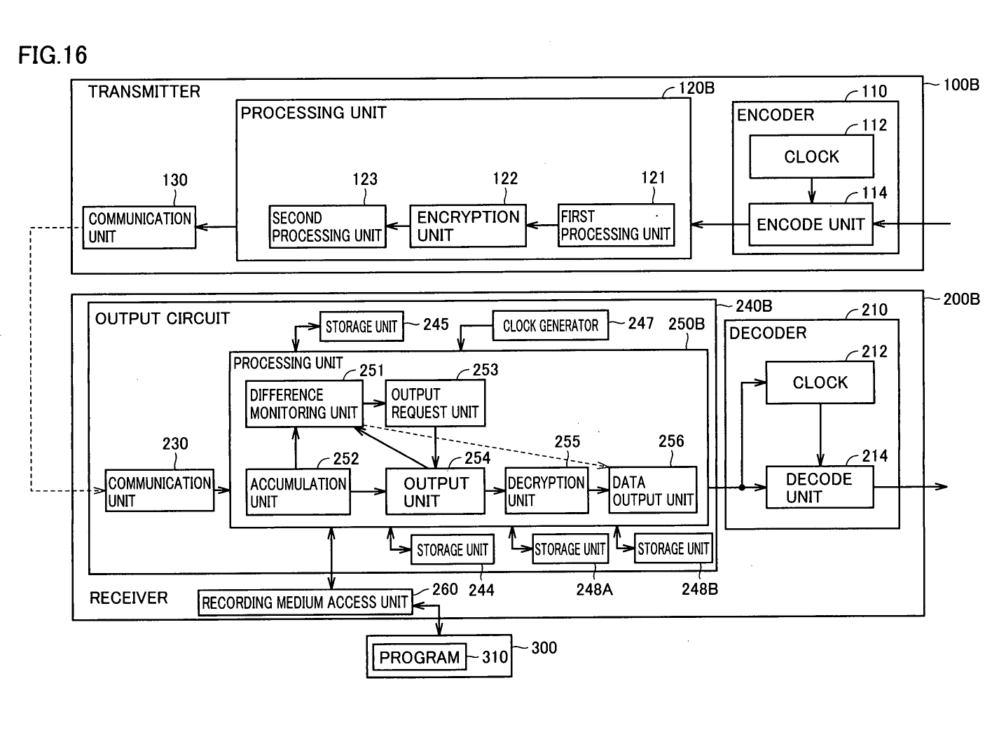

FIG. 16 is a block diagram showing internal configurations of transmitter 100B and receiver 200B of the third embodiment. Referring to FIG. 16, transmitter 100B differs from transmitter 100 of FIG. 10 in that transmitter 100B includes a processing unit 120B instead of processing unit 120. Because other configurations are similar to those of transmitter 100, the detailed description is not repeated.

Because processing unit 120B is a circuit having the same function as processing unit 120, the detailed description is not repeated. Processing unit 120B includes a first processing unit 121, an encryption unit 122, and a second processing unit 123. The functions of processing unit 120B are shared by first processing unit 121, encryption unit 122, and second processing unit 123 which perform the later-mentioned processes. All or part of the units included in processing unit 120B may be configured by hardware.

First processing unit 121 adds time stamp (TS) indicating the timing of reproduction to the MPEG2 data outputted from decoder 110, and transmits the data to encryption unit 122.

Encryption unit 122 encrypts the data received from first processing unit 121. For example, as shown in FIG. 3B, a plurality of pieces of data in which the time stamp is added to the MPEG2 data are collectively encrypted. Examples of the encryption method include DES (Data Encryption Standard) and AES (Advanced Encryption Standard). Encryption unit 122 transmits the encrypted data to second processing unit 123.

Second processing unit 123 converts the data received from encryption unit 122 into the data capable of being transferred on the network. For example, as shown in FIG. 3B, the IP header, the TCP header, and the RTP header are added to the encrypted data. Second processing unit 123 transmits the generated data to communication unit 130.

Communication unit 130 transmits the received data (streaming data) to network 50. The streaming data is streaming data STD 200 of FIG. 3B.

Receiver 200B differs from receiver 200A of FIG. 10 in that receiver 200B includes an output circuit 240B instead of output circuit 240A. Because other configurations are similar to those of receiver 200A, the detailed description is not repeated.

Output circuit 240B differs from output circuit 240A in that not only output circuit 240B further includes a storage unit 248A and a storage unit 248B but also output circuit 240B includes a processing unit 250B instead of processing unit 250. Because other configurations are similar to those of output circuit 240A, the detailed description is not repeated. Similarly to storage unit 244, storage units 248A and 248B have a function as FIFO type buffers in which the data can tentatively be stored.

Because processing unit 250B is a circuit having the same function as processing unit 120, the detailed description is not repeated. Processing unit 250B differs from processing unit 250 in that processing unit 250B further includes a decryption unit 255 and a data output unit 256. Because other configurations are similar to those of processing unit 250, the detailed description is not repeated. That is, similarly to processing unit 250, processing unit 250B has the function of performing various processes according to control program 310. The functions of processing unit 250B are shared by difference monitoring unit 251, accumulation unit 252, output request unit 253, output unit 254, decryption unit 255, and data output unit 256 which perform the later-mentioned processes. All or part of the units included in processing unit 250B may be configured by hardware.

Receiver 200B receives streaming data STD 200 as packets from transmitter 100B through network 50.

Then, each process performed inside output circuit 240B will be described in detail. In the present embodiment, the following various processes are simultaneously started and independently performed.

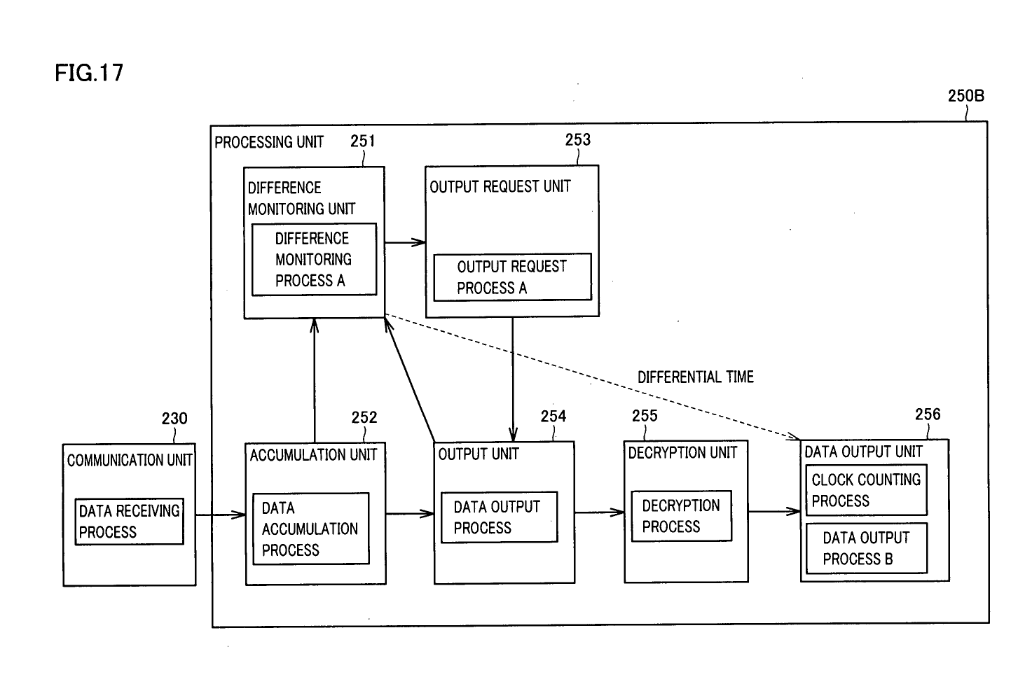

FIG. 17 is a diagram showing processes performed in communication unit 230 and processing unit 250B of the third embodiment. Referring to FIG. 17, communication unit 230 performs the above-described data receiving process of FIG. 12. Accumulation unit 252 performs the above-described data accumulation process of FIG. 5. Difference monitoring unit 251 performs a difference monitoring process A.

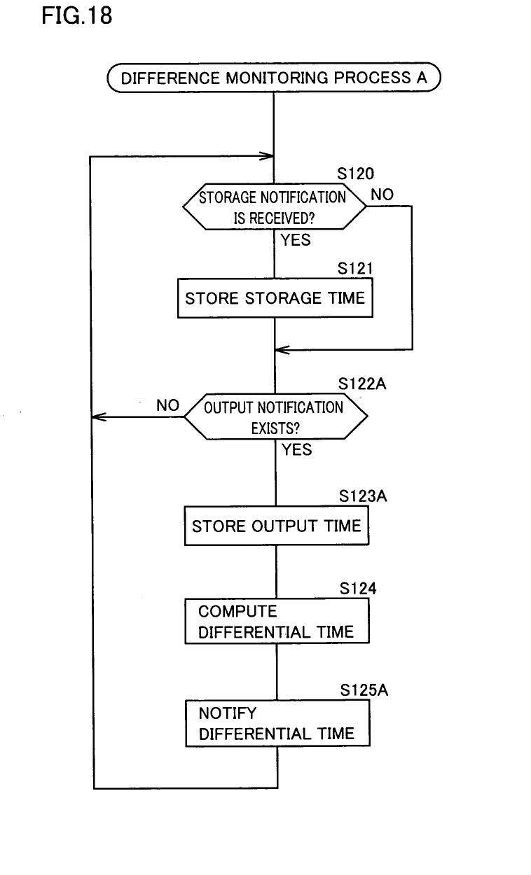

FIG. 18 is a flowchart of the difference monitoring process A. Referring to FIG. 18, the difference monitoring process A differs from the difference monitoring process of FIG. 7 in that the process in step S122A is performed instead of step S122, the process in step S123A is performed instead of step S123, and the process in step S125A is performed instead of step S125. Because other processes are similar to those of the difference monitoring process of FIG. 7, the detailed description is not repeated.

In step S122A, difference monitoring unit 251 determines whether or not the output notification has been received from output unit 254. The leading address (storage address) of storage unit 244 from which the data is read is included in the output notification. As described above, when output unit 254 reads the data from storage unit 244 and outputs the data to decoder 210, output unit 254 transmits the output notification to difference monitoring unit 251. If YES in step S122A, the procedure proceeds to step S123A. On the other hand, if NO in step S122A, the process in step S120 is performed again.

In step S123A, difference monitoring unit 251 stores the time (hereinafter also referred to as output time) at which the output notification is provided in storage unit 245 while the output time is correlated with the storage address included in the output notification. That is, the data in which the storage address, storage time, and output time are correlated with one another is stored in storage unit 245.

In step S125A, difference monitoring unit 251 notifies data output unit 256 of the information on the computed differential time. Then, the process in step S120 is performed again.

Referring to FIG. 17 again, output request unit 253 performs an output request process A.

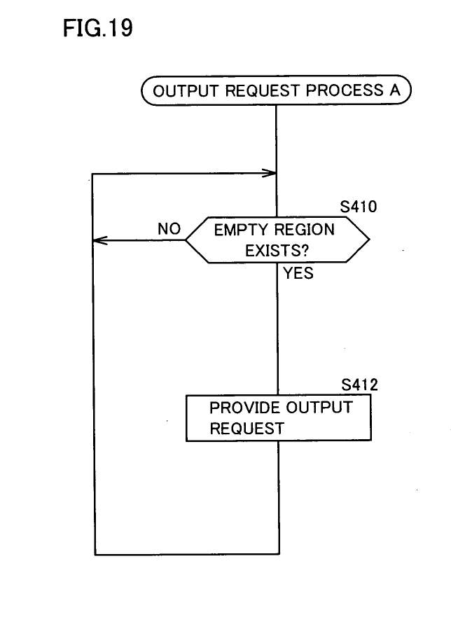

FIG. 19 is a flowchart of the output request process A. Referring to FIG. 19, in step S410, output request unit 253 determines whether or not an empty region exists in storage unit 248A. If YES in step S410, the procedure proceeds to step S412. On the other hand, if NO in step S410, the process in step S410 is performed again.

In step S412, output request unit 253 transmits the data output request to output unit 254. The output request is an output request of the maximum data amount which does not exceed the empty region of storage unit 248A at that time. Then, the process in step S410 is performed again.

Referring to FIG. 17 again, output unit 254 performs the above-described data output process of FIG. 15. In the data output process performed by output unit 254 of the present embodiment, in step S331, the data is stored in storage unit 248A instead of outputting the data to decoder 210.

Decryption unit 255 performs a decryption process.

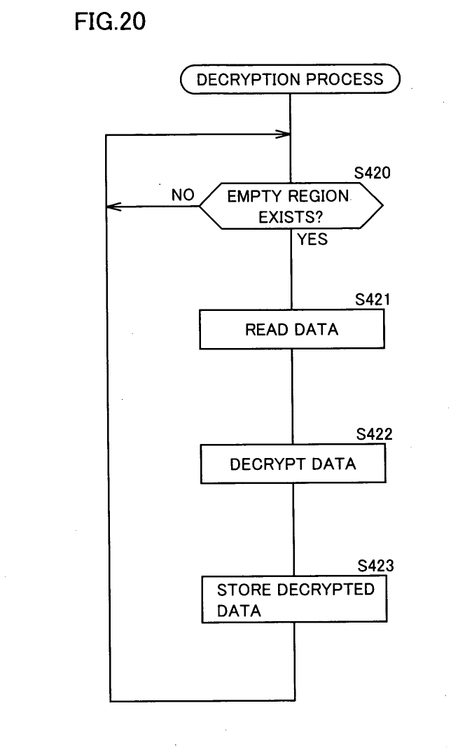

FIG. 20 is a flowchart of the decryption process. Referring to FIG. 20, in step S420, decryption unit 255 determines whether or not an empty region exists in storage unit 248B. If YES in step S420, the procedure proceeds to step S421. On the other hand, if NO in step S420, the process in step S420 is performed again.

In step S421, decryption unit 255 reads the data from storage unit 248A. It is assumed that the amount of data to be read is a maximum amount of data in which the number of bytes of the data does not exceed the empty region of storage unit 248B after the read data is decrypted. Then, the flow goes to step S422.

In step S422, decryption unit 255 decrypts the encrypted data read. For example, in the case where transmitter 100B encrypts the data by AES, the data is decrypted using a decrypting technique by the same AES. Then, the procedure proceeds to step S423.

In step S423, decryption unit 255 stores the decrypted data in storage unit 248B. Then, the process in step S420 is performed again.

Referring to FIG. 17 again, data output unit 256 performs the above-described clock counting process and a data output process B. In the clock counting process of the present embodiment, data output unit 256 performs the process instead of output request unit 253.

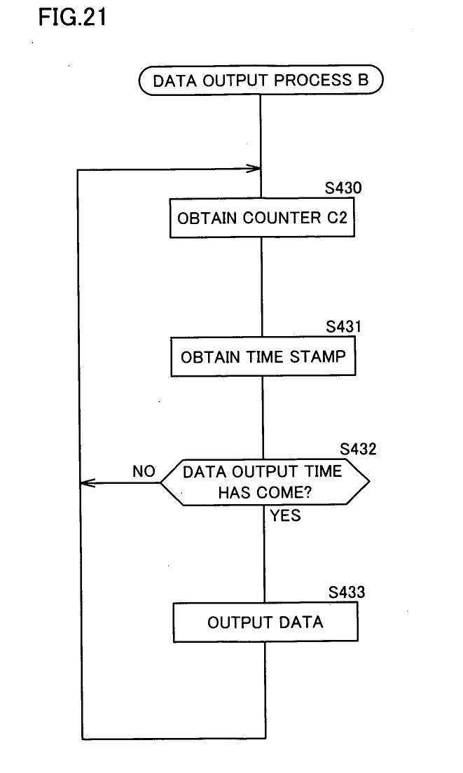

FIG. 21 is a flowchart of the data output process B. Referring to FIG. 21, in step S430, data output unit 256 obtains the value of counter C2, which is updated as needed through the clock counting process of the present embodiment, by reading the value of counter C2 from storage unit 245. Then, the procedure proceeds to step S431.

In step S431, data output unit 256 reads the data having the oldest storage time in the plural pieces of data stored in storage unit 248B. It is assumed that the read data is e.g. streaming data STD100 of FIG. 3A. Then, data output unit 256 obtains the time stamp (TS) of streaming data STD100. Then, the procedure proceeds to step S432.

In step S432, whether or not the output time (timing) of the data has come is determined. Specifically, data output unit 256 determines whether or not the time indicated by the time stamp obtained in step S431 coincides with the value of counter C2 obtained in step S430. If YES in step S432, the procedure proceeds to step S433. On the other hand, if NO in step S432, the process in step S430 is performed again.

In step S433, data output unit 256 reads the data stored in storage unit 248B, and transmits the data to decoder 210. Then, the process in step S430 is performed again.

As described above, in output circuit 240B of the third embodiment, the encrypted streaming data is received through network 50, and the data decrypted by decryption unit 255 is outputted to decoder 210.

The speed at which the data is outputted to decoder 210 is dynamically controlled based on the differential time computed by difference monitoring unit 251. Therefore, even if the value of the time stamp included in the encrypted streaming data is not referred to, the speed at which the data is outputted to decoder 210 can be controlled.

The information on the differential time used to control the timing of the data output is independent of the number of bytes of the data stored in storage unit 248B. Therefore, even if the number of bytes of the data stored in storage unit 248B fluctuates due to the fluctuation in bit rate like VBR, data output unit 256 can output the data stored in storage unit 248B to decoder 210 at correct timing. That is, the effect of outputting the data at correct timing is obtained. That is, advantageously data output unit 256 can accurately control the output speed of the data to be transmitted to decoder 210.

The amount of data outputted from storage unit 244 is the maximum amount of data which does not exceed the empty region of storage unit 248A to which the data is outputted. The amount of data outputted from storage unit 248A is the maximum amount of data which does not exceed the empty region of storage unit 248B to which the data is outputted. Accordingly, the speed at which the data is outputted to decoder 210 can be propagated. That is, when the speed at which the data is outputted to decoder 210 is changed, the speed at which the data is outputted from storage unit 244 is changed accordingly.

As a result, the effect of preventing the generation of overrun or underrun in storage unit 244 is obtained by using the processes of the present embodiment, even if the increase or decrease in data of storage unit 244 due to the time lag between the clocks cannot be monitored with the time stamp value or the number of bytes of the data.

### Fourth Embodiment

In a present embodiment, an output circuit as still another mode of the present invention will be described in detail. The mode in which the output circuit is incorporated into the receiver in the real-time stream transmission will be described by way of example.

A network system of the present embodiment differs from network system 1000 in that the network system includes transmitter 100B instead of transmitter 100 while including receiver 200B instead of receiver 200. Because other configurations are similar to those of network system 1000, the detailed description is not repeated.

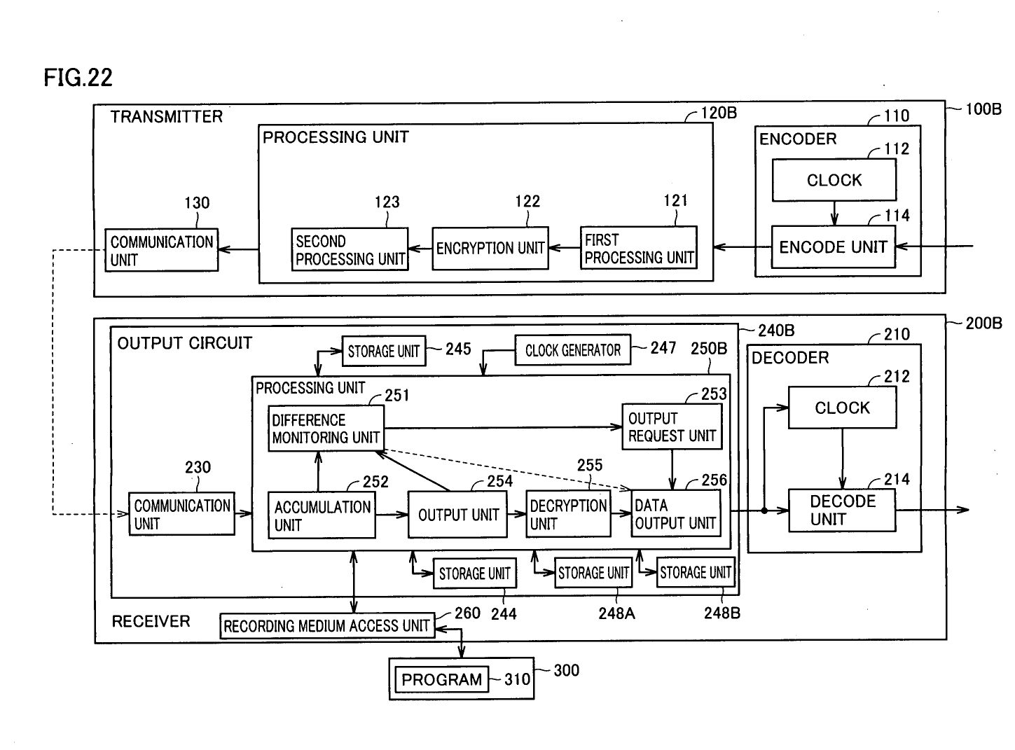

FIG. 22 is a block diagram showing internal configurations of transmitter 100B and receiver 200B of the fourth embodiment. Referring to FIG. 22, because the configurations of transmitter 100B and receiver 200B are similar to those of FIG. 16, the detailed description is not repeated. Although described in detail later, different processes are performed by processing unit 250B of FIG. 22 and processing unit 250B of FIG. 16.

Receiver 200B receives streaming data as packets from transmitter 100B through network 50. The streaming data is streaming data STD 200 of FIG. 3B.

Then, each process performed inside output circuit 240B will be described in detail. In the present embodiment, the following various processes are simultaneously started and independently performed.

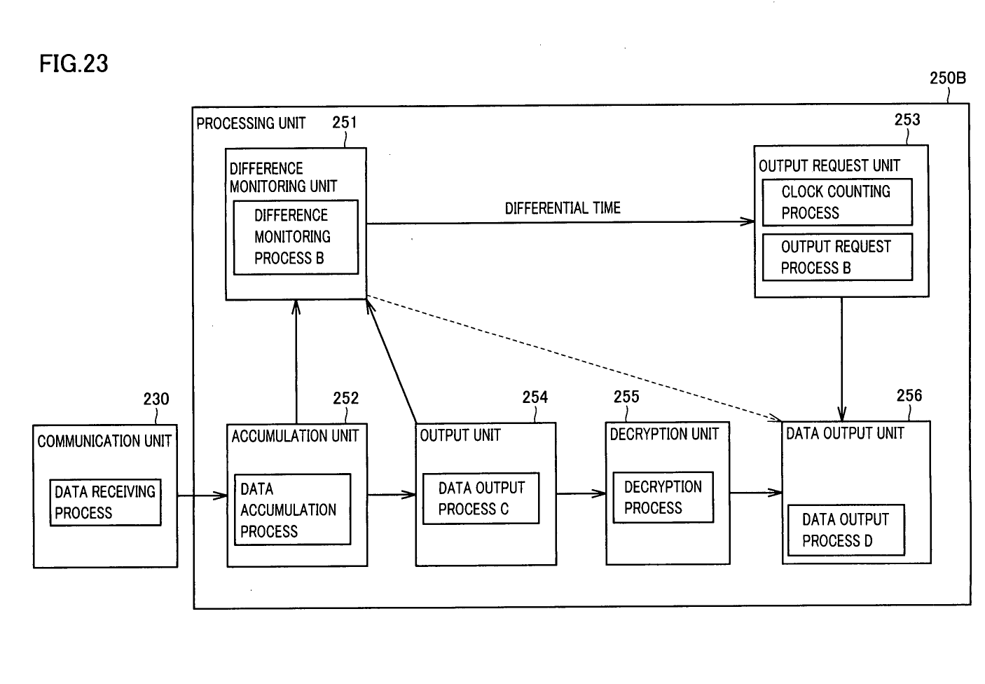

FIG. 23 is a diagram showing processes performed in communication unit 230 and processing unit 250B of the fourth embodiment. Referring to FIG. 23, communication unit 230 performs the above-described data receiving process of FIG. 12. Accumulation unit 252 performs the above-described data accumulation process of FIG. 5. Difference monitoring unit 251 performs a difference monitoring process B.

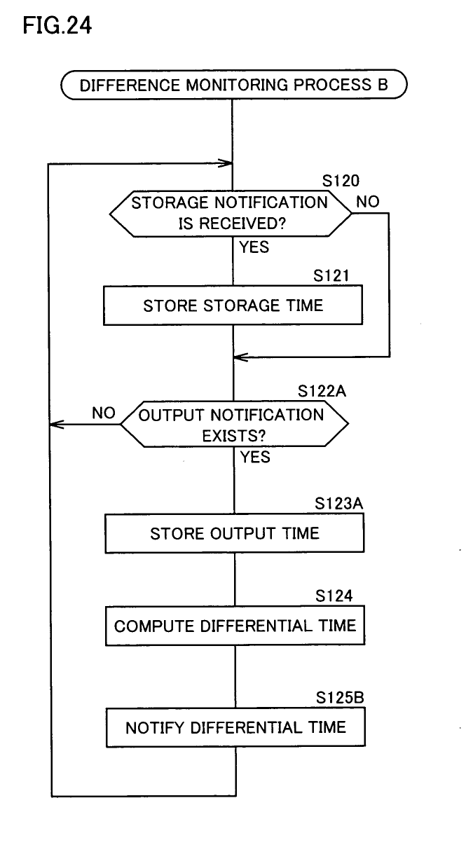

FIG. 24 is a flowchart of the difference monitoring process B. Referring to FIG. 24, the difference monitoring process B differs from the difference monitoring process A of FIG. 18 in that the process in step S125B is performed instead of step S125A. Because other processes are similar to those of the difference monitoring process A of FIG. 18, the detailed description is not repeated.

In step S125B, difference monitoring unit 251 notifies output request unit 253 of the information on the computed differential time. Then, the process in step S120 is performed again.

Referring to FIG. 23 again, output request unit 253 performs the above-described clock counting process of FIG. 13. Output request unit 253 performs an output request process B.

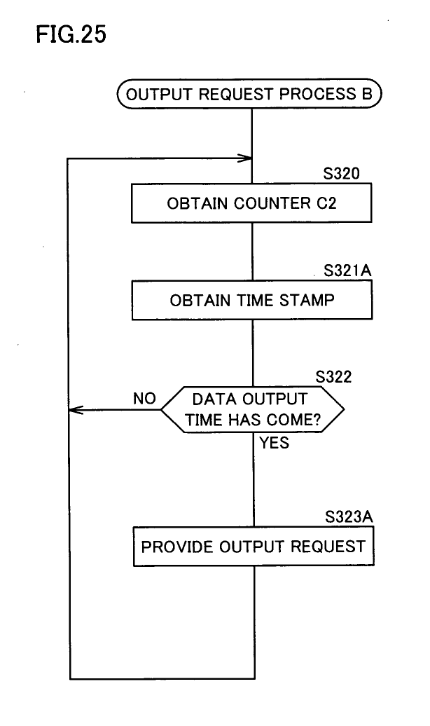

FIG. 25 is a flowchart of the output request process B. Referring to FIG. 25, the output request process B differs from the output request process of FIG. 14 in that the process in step S321A is performed instead of step S321 and the process in step S323A is performed instead of step S323. Because other processes are similar to those of the output request process of FIG. 14, the detailed description is not repeated.

In step S321A, output request unit 253 reads the data having the oldest storage time in the plural pieces of data stored in storage unit 248B. It is assumed that the read data is e.g. streaming data STD100 of FIG. 3A. Then, output request unit 253 obtains the time stamp (TS) of streaming data STD100. Then, the procedure proceeds to step S322.

In step S323A, output request unit 253 transmits the data output request to data output unit 256. Then, the process in step S320 is performed again.

Referring to FIG. 23 again, output unit 254 performs a data output process C.

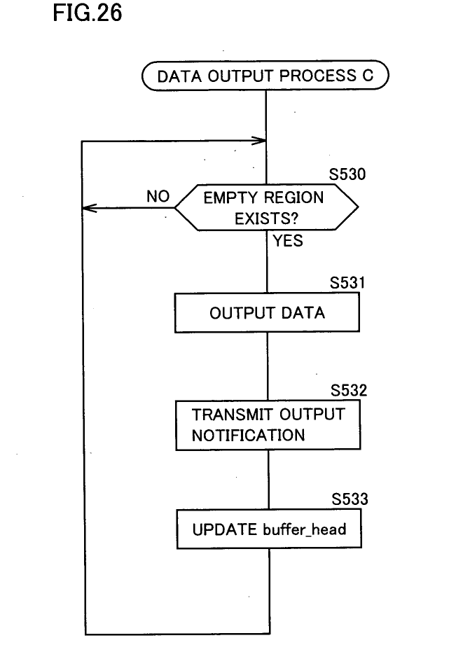

FIG. 26 is a flowchart of the data output process C. Referring to FIG. 26, in step S530, output unit 254 determines whether or not an empty region exists in storage unit 248A. If YES in step S530, the procedure proceeds to step S531. On the other hand, if NO in step S530, the process in step S530 is performed again.

In step S531, output unit 254 refers to the value of the variable buffer_head (see FIG. 6) indicating the current data output position. Output unit 254 reads the data having the maximum amount which does not exceed the empty region of storage unit 248A from storage unit 244 with the storage address of storage unit 244 corresponding to the value of the variable buffer_head set to the leading address. Then, output unit 254 outputs the read data to storage unit 248A. That is, the read data is stored in storage unit 248A. Then, the procedure proceeds to step S532.

In step S532, output unit 254 transmits the output notification that the data has been already outputted to storage unit 248A to difference monitoring unit 251. Then, the procedure proceeds to step S533.

In step 533, output unit 254 increases the value of the variable buffer_head by the number of bytes of the data outputted through the process in step S531, which changes the output position of the next data (packet). Then, the process in step S530 is performed again.

Referring to FIG. 23 again, decryption unit 255 performs the above-described decryption process of FIG. 20. Data output unit 256 performs a data output process D.

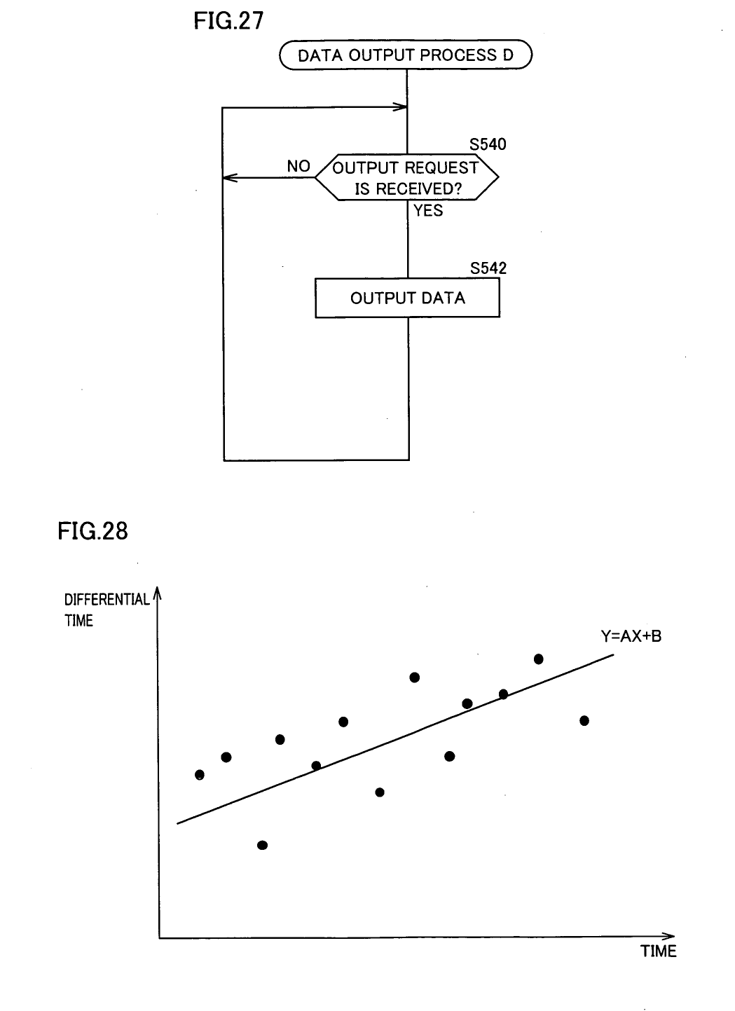

FIG. 27 is a flowchart of the data output process D. Referring to FIG. 27, in step S540, data output unit 256 determines whether or not the output request has been received from output request unit 253. If YES in step S540, the procedure proceeds to step S542. On the other hand, if NO in step S540, the process in step S540 is performed again.

In step S542, data output unit 256 reads the data stored in storage unit 248B, and transmits the data to decoder 210. Then, the process in step S540 is performed again.

As described above, the same effect as the third embodiment is obtained in the processes performed by output circuit 240B of the fourth embodiment.

### Fifth Embodiment

In a present embodiment, still another mode of the output circuit will be described.

A network system of the present embodiment differs from network system 1000 in that the network system includes a receiver 200C instead of receiver 200. Because other configurations are similar to those of network system 1000, the detailed description is not repeated.

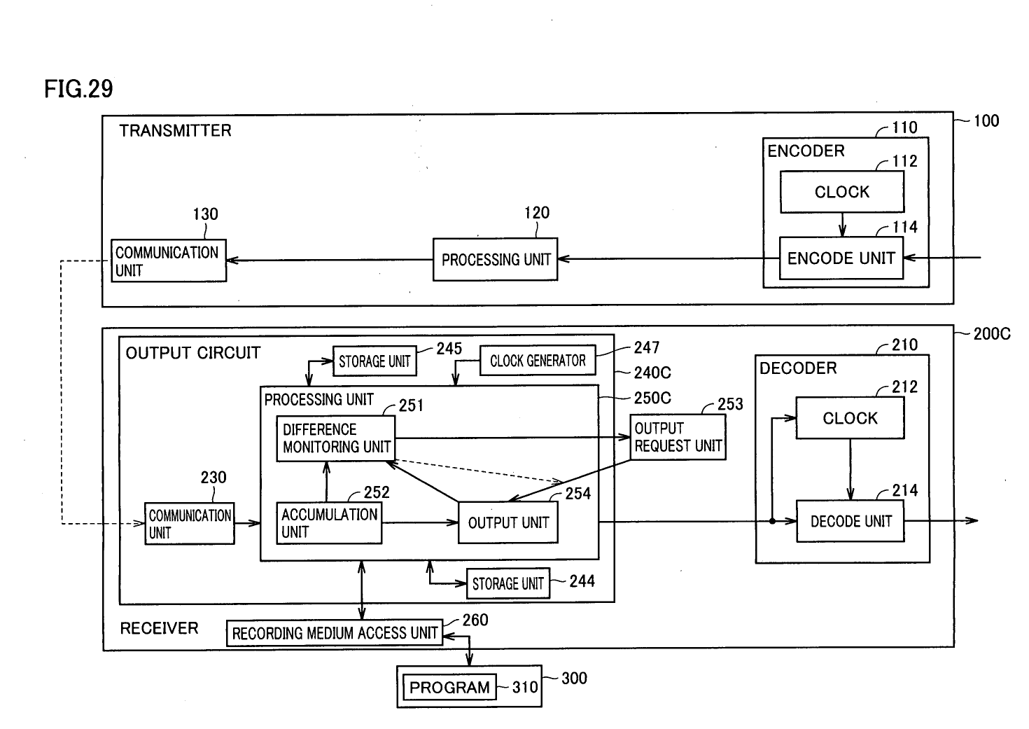

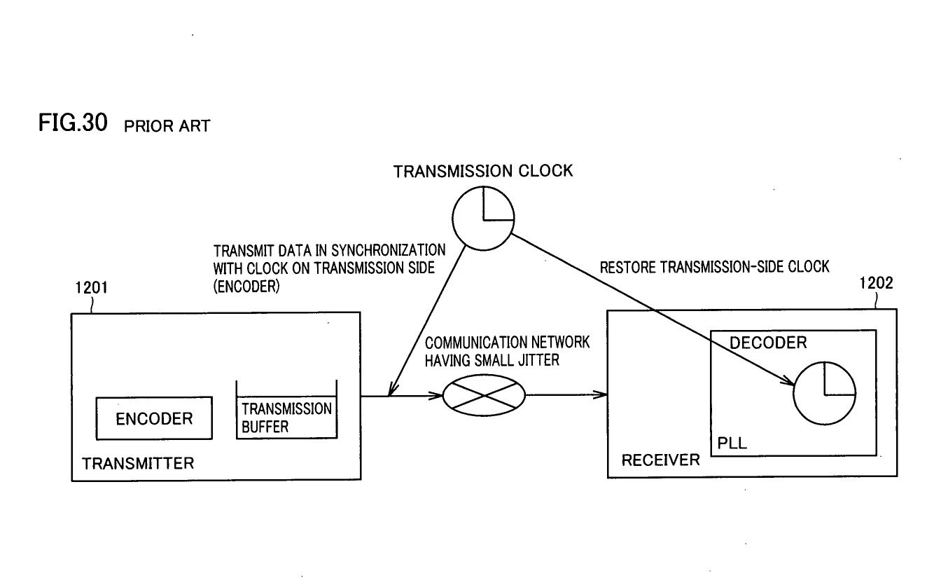

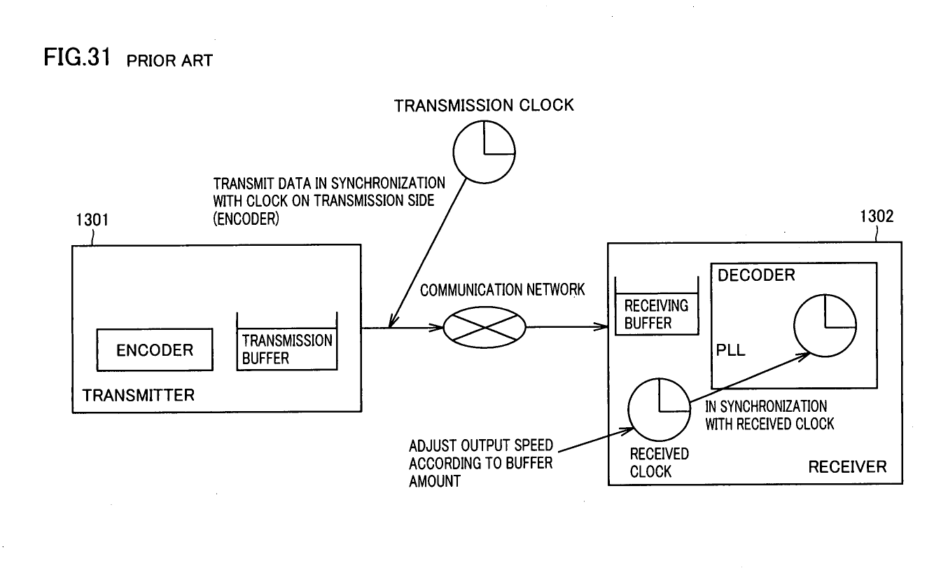

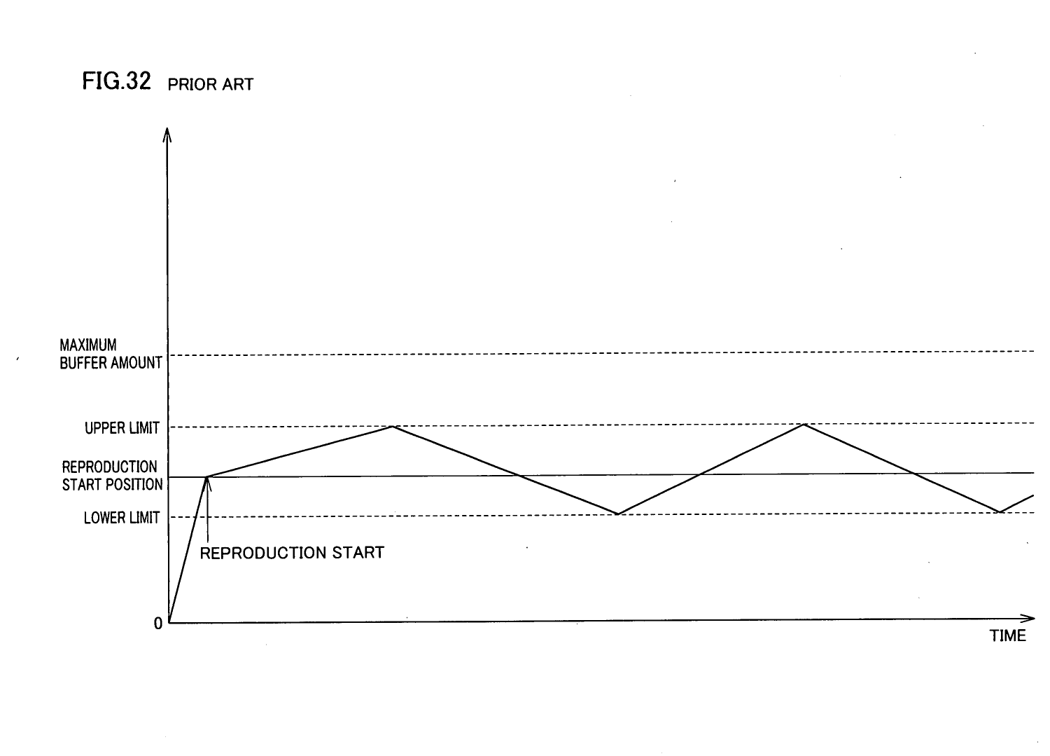

FIG. 29 is a block diagram showing internal configurations of transmitter 100 and receiver 200C of the fifth embodiment. Referring to FIG. 29, receiver 200C differs from receiver 200A of FIG. 10 in that receiver 200C further includes output request unit 253 while including an output circuit 240C instead of output circuit 240A. Because other configurations are similar to those of receiver 200A, the detailed description is not repeated.

Output circuit 240C differs from output circuit 240A in that output circuit 240C includes a processing unit 250C instead of processing unit 250. Because other configurations are similar to those of output circuit 240A, the detailed description is not repeated.

Processing unit 250C differs from processing unit 250 of FIG. 10 in that processing unit 250C does not include output request unit 253. Because other configurations are similar to those of processing unit 250, the detailed description is not repeated. That is, similarly to processing unit 250, processing unit 250C has the function of performing various processes according to control program 310. The functions of processing unit 250C are shared by difference monitoring unit 251, accumulation unit 252, and output unit 254. All or part of the units included in processing unit 250C may be configured by hardware.

That is, receiver 200C differs from receiver 200A in that output request unit 253 is provided outside output circuit 240C. Output request unit 253 is configured by hardware. That is, output request unit 253 is an external circuit with respect to output circuit 240C.

In the present embodiment, the processes performed by difference monitoring unit 251, accumulation unit 252, output request unit 253, and output unit 254 are similar to those of the second embodiment, so that the detailed description is not repeated.

Thus, the differential time computed by difference monitoring unit 251 is transmitted (notified) to output request unit 253. In this case, the differential time becomes information for controlling the timing at which output request unit 253 provides the output request.

Accordingly, the same effect as the second embodiment can be obtained by receiver 200C of the present embodiment.

### Modification of Fifth Embodiment

A process in which an external circuit of the output circuit computes the differential time will be described in a present embodiment.

In the present embodiment, because a network system is similar to that of the fifth embodiment, the detailed description is not repeated. Accordingly, FIG. 29 is the block diagram showing the internal configurations of transmitter 100 and receiver 200C in the present embodiment.

In the present embodiment, because accumulation unit 252 performs the same process (data accumulation process of FIG. 5) as the second embodiment, the detailed description is not repeated.

Difference monitoring unit 251 performs the processes in steps S120, S121, and S122 of the difference monitoring process of FIG. 7. Output request unit 253 provides the output request to output unit 254 in step S122, and the process in step S123 is performed.

Difference monitoring unit 251 transmits (notifies) the output time stored through the process in step S123 and the storage time corresponding to the output time to output request unit 253 which is the external circuit.

Output request unit 253 computes the differential time between the received output time and the storage time corresponding to the output time. Since the computation of the differential time is similar to the process in step S124 performed by difference monitoring unit 251, the detailed description is not repeated. In this case, the computed differential time becomes information for controlling the timing at which output request unit 253 provides the output request. That is, the output time and the storage time corresponding to the output time, received by output request unit 253, become the information for controlling the timing at which output request unit 253 provides the output request.

Accordingly, the same effect as the second embodiment can be obtained in receiver 200C of the present embodiment.

Output circuit 240 of the first embodiment and difference monitoring unit 251 in the output circuit of the second to fifth embodiments perform the process of computing the differential time. In the second embodiment, output request unit 253 utilizes the differential time to control the speed at which output unit 254 outputs the data.

In the third embodiment, data output unit 256 utilizes the differential time to control the speed at which the data is outputted. In the fourth embodiment, output request unit 253 utilizes the differential time to control the speed at which data output unit 256 outputs the data. The control of the speed at which each of the second data to fourth data is outputted is one in which the data output speed is increased when the differential time reaches a predetermined upper limit while the data output speed is decreased when the differential time reaches a predetermined lower limit.

However, in the present invention, the following processes may be performed without being limited to the above-described processes.

FIG. 28 is a graph showing change in differential time as time advances. Referring to FIG. 28, using predetermined pieces of data of the differential time which changes as time advances, difference monitoring unit 251 computes a straight line Y=AX+B as a characteristic by a computation method such as a least-square method. That is, the characteristic of the differential time is computed.

In this case, A indicating a gradient of the straight line is a value in which the amount of data of the storage unit (buffer) is divided by an observed time. That is, A indicates a time lag of the progress of time between the transmitter and the receiver.

A becomes zero when decoder 210 reproduces the data at the speed at which encoder 110 of the transmitter outputs the data. However, A becomes a numerical value except zero when the time lag in the clock exists between the transmitter and the receiver.

Therefore, correction value H per unit time is set to A in the clock counting process of each embodiment. In each embodiment, using the set correction value, the processing unit (for example, processing unit 250, processing unit 250B, and processing unit 250C) which performs the clock counting process controls the speed at which the processing unit (for example, output unit 254 and data output unit 256) outputs the data to decoder 210.

Through the above-described process, the clock speed of the transmitter and the clock speed of the receiver are brought close to each other as time advances. Accordingly, the effect of preventing the generation of overrun or underrun is obtained.

Although each of the units of the present invention is performed by the same processing unit, the units may be performed by different processing units respectively. For example, the output request unit may be operated on another processing unit to notify the output request unit located on a different processing unit of the differential information obtained by the difference monitoring unit, or a different processing unit may be notified of the storage time and output time to be the basis of the differential computation and compute the difference to provide the output request.

In the present invention, the differential time is computed by the computation of the difference between the time at which the data A is stored in storage unit 244 and the time at which the data A is outputted from storage unit 244. That is, the differential time is computed by focusing on the same data which is the data A. However, the differential time may be computed by the following computation method A.

The computation method A is a method of computing the differential time in the case where predetermined pieces (for example, two) of data are stored in storage unit 244 during a period until the data B is stored in storage unit 244 since the data A is stored in storage unit 244. The predetermined pieces may be zero. It is assumed that time t1 is the time at which the data A is stored in storage unit 244 while time t2 is the time at which the data B is outputted from storage unit 244. In this case, in the computation method A, the differential time is computed by computing the time period corresponding to the difference between time t1 and time t2. That is, the differential time can also be computed by focusing on two different pieces of data.

The differential time may be computed by the following computation method B.

In the computation method B, the value of the clock counter which counts the clock outputted from clock generator 247 is set to zero at the time when the data A is stored in storage unit 244, and the value of the clock counter at the time when the data A is outputted from storage unit 244 is read to compute the differential time. Hereinafter the value of the clock counter is also referred to as the number of clock counts.

The differential time may be computed by a computation method C in which the computation method A and the computation method B are combined. The computation method C is a method of computing the differential time in the case where predetermined pieces (for example, two) of data are stored in storage unit 244 during a period until the data B is stored in storage unit 244 since the data A is stored in storage unit 244. The predetermined pieces may be zero. It is assumed that time t3 is the time at which the data A is stored in storage unit 244 while time t4 is the time at which the data B is outputted from storage unit 244. In this case, in the computation method C, the value of the clock counter is set to zero at the time t3, and the value of the clock counter is read at the time t4 to compute the differential time.

It is noted that the disclosed embodiments are illustrated only by way of example and thus nonrestrictive. The scope of the present invention is determined by not the above descriptions but the appended claims, and obviously it is intended that the present invention include the meanings equivalent to the scope of the claims and modifications and changes within the scope of the claims.

1. An output circuit comprising:
a storage unit to store data;
an accumulation unit to store the data in said storage unit;
an output request unit to provide an output request for the data stored in said storage unit;
an output unit to output the data stored in said storage unit in response to said output request; and
a computation unit to compute an elapse time until said output unit outputs second data stored in said storage unit since said accumulation unit stores first data in said storage unit, wherein
said output request unit changes a speed at which said output unit outputs the data based on said elapse time.

2. The output circuit according to claim 1, wherein said output request unit increases the speed at which said output unit outputs the data when said elapse time reaches a predetermined upper limit, and said output request unit decreases the speed at which said output unit outputs the data when said elapse time reaches a predetermined lower limit.

3. The output circuit according to claim 1, wherein
said computation unit computes a characteristic of said elapse time for a predetermined time by a predetermined calculation using predetermined pieces of information on said elapse time which is changed based on the data stored in said storage unit, and
said output request unit changes the speed at which said output unit outputs the data based on the characteristic of said elapse time.

4. The output circuit according to claim 3, wherein said predetermined calculation is a calculation by a least-square method.

5. The output circuit according to claim 1, wherein said elapse time is a time period corresponding to a difference between time at which said accumulation unit stores said first data in said storage unit and time at which said output unit outputs said second data stored in said storage unit.

6. The output circuit according to claim 1, wherein said elapse time is a time period based on the number of clock counts counted until said output unit outputs said second data stored in said storage unit since said accumulation unit stores said first data in said storage unit.

7. The output circuit according to claim 1, wherein said first data and said second data are the same data.

8. The output circuit according to claim 1, wherein predetermined pieces of data are stored in said storage unit during a period until said second data is stored in said storage unit since said first data is stored in said storage unit.

9. An output circuit comprising:
a storage unit to store data;
an accumulation unit to store encrypted data in said storage unit;
an output request unit to provide an output request for the encrypted data stored in said storage unit;
a first output unit to output the encrypted data from said storage unit in response to said output request;
a decryption unit to decrypt the encrypted data outputted from said first output unit;
a second output unit to output the decrypted data decrypted by said decryption unit; and
a computation unit to compute an elapse time until said first output unit outputs second encrypted data stored in said storage unit since said accumulation unit stores first encrypted data in said storage unit, wherein
said second output unit changes a speed at which said decrypted data is outputted based on said elapse time.

10. The output circuit according to claim 9, wherein said second output unit increases the speed at which said decrypted data is outputted when said elapse time reaches a predetermined upper limit, and said second output unit decreases the speed at which said decrypted data is outputted when said elapse time reaches a predetermined lower limit.

11. The output circuit according to claim 9, wherein
said computation unit computes a characteristic of said elapse time for a predetermined time by a predetermined calculation using predetermined pieces of information on said elapse time which is changed based on the encrypted data stored in said storage unit, and
said second output unit changes the speed at which said decrypted data is outputted based on the characteristic of said elapse time.

12. The output circuit according to claim 11, wherein said predetermined calculation is a calculation by a least-square method.

13. The output circuit according to claim 9, wherein said first encrypted data and said second encrypted data are the same data.

14. An output circuit comprising:
a storage unit to store data;
an accumulation unit to store encrypted data in said storage unit;
a first output unit to output the encrypted data from said storage unit;
a decryption unit to decrypt the encrypted data outputted from said first output unit;
a second output unit to output the decrypted data decrypted by said decryption unit in response to an output request;
an output request unit to provide said output request to said second output unit; and
a computation unit to compute an elapse time until said first output unit outputs second encrypted data stored in said storage unit since said accumulation unit stores first encrypted data in said storage unit, wherein
said output request unit changes a speed at which said second output unit outputs said decrypted data based on said elapse time.

15. The output circuit according to claim 14, wherein said output request unit increases the speed at which said second output unit outputs said decrypted data when said elapse time reaches a predetermined upper limit, and said output request unit decreases the speed at which said second output unit outputs said decrypted data when said elapse time reaches a predetermined lower limit.

16. The output circuit according to claim 14, wherein
said computation unit computes a characteristic of said elapse time for a predetermined time by a predetermined calculation using predetermined pieces of information on said elapse time which is changed based on the encrypted data stored in said storage unit, and
said output request unit changes the speed at which said second output unit outputs said decrypted data based on the characteristic of said elapse time.

17. The output circuit according to claim 16, wherein said predetermined calculation is a calculation by a least-square method.

18. The output circuit according to claim 14, wherein said first encrypted data and said second encrypted data are the same data.

19. An output circuit which outputs data in response to an output request from an external circuit, the output circuit comprising:
a storage unit to store data;
an accumulation unit to store the data in said storage unit;
an output unit to output the data stored in said storage unit in response to said output request; and
a computation unit to compute an elapse time until said output unit outputs second data stored in said storage unit since said accumulation unit stores first data in said storage unit, and to notify said external circuit of said elapse time as information for controlling timing of said output request.

20. The output circuit according to claim 19, wherein said elapse time is a time period corresponding to a difference between time at which said accumulation unit stores said first data in said storage unit and time at which said output unit outputs said second data stored in said storage unit.

21. The output circuit according to claim 19, wherein said elapse time is a time period based on the number of clock counts counted until said output unit outputs said second data stored in said storage unit since said accumulation unit stores said first data in said storage unit.

22. The output circuit according to claim 19, wherein said first data and said second data are the same data.

23. The output circuit according to claim 19, wherein predetermined pieces of data are stored in said storage unit during a period until said second data is stored in said storage unit since said first data is stored in said storage unit.

24. An output circuit which outputs data in response to an output request from an external circuit, the output circuit comprising:
a storage unit to store data;
an accumulation unit to store the data in said storage unit;
an output unit to output the data stored in said storage unit in response to said output request; and
a notification unit to notify said external circuit of time at which said accumulation unit stores first data in said storage unit and time at which said output unit outputs second data stored in said storage unit as information for controlling timing of said output request.

25. The output circuit according to claim 24, wherein said first data and said second data are the same data.

26. A control program product which causes a computer to perform data processing, the control program product causing the computer to execute the steps of:
storing data in a storage unit of the computer;
providing an output request for the data stored in said storage unit;
outputting the data stored in said storage unit in response to said output request;
computing an elapse time until second data stored in said storage unit is outputted since first data is stored in said storage unit; and
changing a speed at which the data is outputted based on said elapse time.

27. The control program product according to claim 26, wherein said first data and said second data are the same data.

28. A control method performed by an output circuit provided with a storage unit, said control method comprising the steps of:
storing data in said storage unit; providing an output request for the data stored in said storage unit;
outputting the data stored in said storage unit in response to said output request;
computing an elapse time until second data stored in said storage unit is outputted since first data is stored in said storage unit; and
changing a speed at which the data is outputted based on said elapse time.

29. The control method according to claim 28, wherein said first data and said second data are the same data.
